(19) United States
(12) Patent Application Publication
(10) Pub. No.: US 2016/0178074 A1
(43) Pub. Date: Jun. 23, 2016

(54) RAPID EXHAUST VALVE FOR RAILWAY VEHICLES AND PIPING SYSTEM OF RAILWAY VEHICLE

(71) Applicant: KITZ CORPORATION, Chiba (JP)

(72) Inventor: Kazuhiro AOKI, Nagano (JP)

(21) Appl. No.: 14/909,308

(22) PCT Filed: Aug. 4, 2014
(86) PCT No.: PCT/JP2014/070515

§ 371 Date: Feb. 1, 2016

(30) Foreign Application Priority Data
Aug. 2, 2013 (JP) 2013-161658
Feb. 14, 2014 (JP) 2014-026365

(51) Int. Cl. F16K 11/087; E05F 15/56

(52) U.S. Cl. CPC F16K 11/0873; E05F 15/565

(57) ABSTRACT

A rapid exhaust valve for railway vehicles and a piping system of a railway vehicle, the piping system using the rapid exhaust valve, are provided. The rapid exhaust valve rapidly discharges pressure air from an automatic door opening/closing gear of a railway vehicle to allow manual operation of an automatic door, is made compact in overall size while giving an exhaust outlet a large bore diameter to reduce a venting time to keep it within a given time, shows superior operability to certainly prevent leakage at channel switching, allows a change in a piping direction and an operation direction according to an installation location while keeping the number of components small, and switches a channel to allow rapid venting from a desired pipeline.

### TECHNICAL FIELD

The present invention relates to a rapid exhaust valve for railway vehicles which exhaust valve is for use, for example, in piping, etc., for a pneumatic automatic door opening/closing gear of a railway vehicle and is provided to discharge pressure air from a pneumatic piston cylinder of the door opening/closing gear by closing a channel to a pipeline on the air pressure supply side, and to a piping system using the exhaust valve.

### BACKGROUND ART

Conventionally, a pneumatic automatic door opening/closing gear of a railway vehicle is so structured as to meet such demands that in the even of an emergency situation, occupants should be allowed to quickly escape to outside the railway vehicle and that in a case where repair/maintenance work is necessary, a worker should be allowed to quickly enter the railway vehicle. In such a situation or case, therefore, the door opening/closing gear allows the door to be opened manually from inside or outside the railway vehicle. To allow such a manual operation, an air channel for the door opening/closing gear is provided with an emergency cock valve. This cock valve is closed to stop supplying pressure air to a channel leading from an air tank to a door cylinder and at the same time, connect an exhaust port formed on the valve element of the cock valve communicatively to an exhaust outlet formed on the body of the cock valve, thereby release pressure air accumulated in the door cylinder to the outside. Through this process, the door opening/closing gear is set free from constraint by pressure air, thus allowing the door to be opened freely.

For example, a ball cock valve for railway vehicles disclosed in patent document 1 is known as a valve for use in such a door opening/closing gear. This valve is a two-way ball cock valve and is provided in the side wall of a railway vehicle or in piping outside the railway vehicle. The ball cock valve is structured such that an almost spherical ball valve element is disposed in a body and that an exhaust outlet is formed between a ball seat for a primary-side hole and a ball seat for a secondary-side hole in the body. The ball valve element has a communicating hole connecting the primary-side hole communicatively to the secondary-side hole and an exhaust port connecting the secondary-side hole communicatively to the exhaust outlet. By rotating the ball valve element, the secondary-side hole is connected communicatively to the exhaust outlet through the exhaust port as the primary-side is kept cut off from the secondary-side. As a result, pressure air in piping on the secondary-side is discharged through the exhaust outlet to allow manual opening/closing of a door.

Patent document 2 discloses a ball cock structured such that a pipe joint is disposed in an exhaust outlet of a body, to which pipe joint an extension pipe with a curved portion is connected, and air is discharged from the secondary side through the extension pipe.

Patent document 3 discloses a ball cock structured such that a strainer is disposed between a valve seat and a primary-side pipe fitting hole so that the strainer gets rid of a foreign object from the primary-side pipe fitting hole to prevent jamming, scratching, etc., caused by such a foreign object as rust that enters piping leading to the vale seat when an exhaust outlet of a body is connected communicatively to an exhaust outlet of a valve element or no venting operation is carried out.

Such a floating-type channel switching valve as described above must ensure its airtightness against high-pressure compressed air when the valve is fully opened or closed. To meet this requirement, the valve has a seal structure in which a washer disposed behind the valve seat presses the valve seat against the valve element.

For example, according to a ball valve disclosed in patent document 4, a valve seat is housed in a recession of an intermediate element, which is a seat retainer interposed at an intermediate position, and the intermediate element is pressed by a spring washer (leaf spring) toward a valve element. In addition, a seal ring is fitted in a ring slot of a body. These intermediate element and seal ring ensure airtightness and prevent the wearout of the valve seat caused by handle manipulations.

A ball valve disclosed in patent document 5 is structured such that valve seat support members serving as seat retainers are provided on the primary side and the secondary side, respectively, and that a sealing valve seat is supported by these valve seat support members. The vertical sectional area of the valve seat support members is determined to be larger than the opening area of the valve seat to provide a structure that prevents a leakage of compressed air flowing in from a primary-side channel and a secondary-side channel.

The above ball valve is usually opened and closed manually, using a handle. In such a case, the rotation of the handle can be regulated in many cases so that the valve element is rotated to a given opened/closed state.

For example, a cock disclosed in patent document 6 includes a handle having a locking projection and a stopper plate having a locking piece, and the rotation of a valve element is regulated by engaging the locking projection with the locking piece. According to this cock, by fitting the stopper plate and handle at arbitrary angles, the direction of the handle as well as the direction of operation of the handle can be changed according to usage, installation positions, etc.

When the handle is installed in such a manner, because a railway vehicle accompanies lots of vibrations, it is desirable for the railway vehicle to have a mechanism that prevents malfunction caused by such vibrations, operational errors, etc.

For example, according to a ball cock disclosed in patent document 7, a lock member (lock leaf spring) is disposed on the back of a handle, and an engaging portion of the lock leaf spring is fitted in an engaging slot of a body to lock the ball cock into a given operation state.

An emergency-release cock disclosed in patent document 8 includes a lever-shaped handle that can be operated inside a railway vehicle and a locking device disposed near the handle, which locking device regulates the rotation of the handle.

A two-way cock valve or three-way cock valve with an exhaust outlet may be employed as a cock valve having a structure other than the structures of the above valves. Each of the two-way cock valve and three-way cock valve is structured such that an almost conical cock valve element having an internal channel and an exhaust port is disposed in a body and that when the cock valve element is rotated to connect the port communicatively to an exhaust outlet formed on the body, internal pressurize air is discharged.

### PRIOR ART DOCUMENTS

### Patent Documents

[patent document 1] Japanese Examined Utility Model Application Publication No. 6-23802
[patent document 2] Japanese Unexamined Patent Application Publication No. 10-273040
[patent document 3] Japanese Unexamined Patent Application Publication No. 11-304020
[patent document 4] Japanese Unexamined Patent Application Publication No. 61-198777
[patent document 5] Japanese Unexamined Patent Application Publication No. 62-194174
[patent document 6] Japanese Unexamined Patent Application Publication No. 62-22365
[patent document 7] Japanese Examined Utility Model Application Publication No. 4-40060
[patent document 8] Japanese Patent No. 3541316

### SUMMARY OF THE INVENTION

### Problems to be Solved by the Invention

In the case of the valve that carries out venting on the secondary side through the exhaust outlet of the body, which valve is described in patent documents 1 to 3, it is necessary to bore the exhaust outlet on the body and to form the exhaust port on the valve element such that the exhaust port is bored at a position at which it does not interfere with the communicating hole, by forming a slant through-hole at that position. In this structure, forming the large-sized exhaust port of the valve element becomes difficult. For example, a ball cock for a pipe ⅜B uses a valve element with a communicating hole diameter of 10 mm and a ball diameter of 20 mm. An exhaust port bored on this valve element is limited in size and is about 3 mm in diameter at maximum. As a result, if the length of the secondary-side pipeline is larger than a certain length, exhausting the secondary-side pipeline of air takes a long time, which is, for example, equal to or longer than 5 seconds. Therefore, in the case of the ball cock valve having the ball valve element, as described in the above patent documents, matching the diameter size of the exhaust port to the bore diameter size of the channel is difficult. For this reason, in many cases, the diameter size of the exhaust port is determined to be about 10% of the bore diameter size of the channel for the ordinary ball valve element.

When a three-way switching valve for venting is to be provided in the form of the ball cock valve, forming its body into a one-piece structure is difficult. As a result, the valve as a whole becomes larger in size as the number of retainers, etc., supporting the valve seat increases, which results in an increase in the number of components.

When an exhaust outlet is formed on the body, the position of the exhaust outlet must be examined as protecting a worker from air blast during repair/maintenance work and preventing foreign object entry, water infiltration, freezing, etc., are taken into consideration. However, the exhaust outlet must be formed at a position at which the exhaust outlet communicates with a port of the valve element. The positioning of the exhaust outlet is thus limited, in which case freely setting the direction of high-pressure air to be discharged according to a valve piping environment is difficult.

To allow the above ball valve to ensure a large flow rate in its open-valve mode, the valve should preferably be provided as a full-bore type valve, which is advantageous to ensuring a large flow rate. However, due to the structural characteristics of the ball valve, it must have a two-piece structure when turned into a full-bore type valve. It is necessary in this case that a joint on the body be provided with a sealing component that prevents high-pressure air leakage and a screw-fastened part on the body be provide with a means for preventing its loosening during piping construction. This leads to a complicated structure, an increase in the overall size, and an increase in the number of components.

Such a floating-type ball valve in the above case has a structure in which the valve element is moved by an air pressure in full-closed mode to the secondary side and the secondary valve seat and the valve element jointly create a sealed environment. As a result, the sealing performance of the primary valve seat and valve element deteriorates. When a sealing surface pressure drops due to the wearout of the valve seat, an air leak to the outside may occur in full-open mode, etc.

To compensate these disadvantages, according to the ball valves of patent documents 4 and 5, the back and side of the valve seat is enclosed with a metal seat retainer, and a leaf spring at the back of the seat retainer pushes the valve seat against the valve element to ensure the sealing performance on the primary side in full-closed mode.

According to these ball valves, however, the leaf spring is provided only on the primary valve seat side. The pressing force of the leaf spring, therefore, contributes to the sealing performance in full-closed mode but acts only on the primary valve seat in full-open mode in which the ball is restrained from moving by the valve shaft, thus not acting on the secondary valve seat in full-open mode. For this reason, air leakage from the secondary valve seat tends to happen in full-open mode. When such a valve is manually operated with the handle, its operability turns out to be irregular, which further deteriorates the operability and sealing performance of the valve.

In the case of providing the operating handle, the valve of patent document 6 requires the handle with the locking projection and the stopper plate with the locking piece. This makes the valve structure complicated and increases the number of components. In addition, when the direction of operation of the handle is set according to the position of installation of the valve, a combination of the mounting direction of the handle and the mounting direction of the stopper plate must to be taken into consideration. As a result, different types of handles and locking pieces are required, and setting those handles and locking pieces is cumbersome.

When the valve is provided with the lock member or locking device to prevent malfunction of the operating handle, as in the case of patent documents 7 and 8, these components newly incorporated in the valve complicate its structure, thus posing a problem of an increase in the overall size. In many cases, multiple valves for railway vehicles are arranged in a narrow piping space. Compactifying a valve for railway vehicles is thus in demand.

The two-way cock valve with the exhaust outlet requires a lapping process for enabling sealing of a metal contact surface between the almost conical cock valve element and a conical tapered surface formed in the body, thus requiring a wide sealing area for preventing galling and wearing, which makes formation of a large exhaust port difficult. As a result, as in the case of the ball cock valve, the port diameter (5 mm) is determined to be about 15% or less of the bore diameter of the cock valve element.

These facts lead to a conclusion that in the case of the conventional two-way ball cock valve with the exhaust outlet and two-way or three-way cock valve with the exhaust outlet, the exhaust port cannot be enlarged in diameter. In addition, when such a valve is used in a railway vehicle as the valve is kept compact, it takes a long time to exhaust the pipeline connected to the door opening/closing gear of air to a point at which the door can be manually opened in an emergency situation, because of which quick evacuation in an emergency situation or swift repair/maintenance work may become impossible.

In the same railway vehicle, pressure air discharge volumes vary depending on the number of doors to be opened and the arrangement of valves in piping, and therefore venting times vary. In different types of railway vehicles, different piping layouts are adopted, which results in different piping capacities, thus leading to different venting times. When the above two-way ball cock valve or two-way or three-way cock valve is used in the railway vehicle, therefore, it is difficult to reduce the venting time to keep it within a given time by adjusting the area of the exhaust outlet.

The present invention was developed in order to solve the above problems, and it is therefore the object of the present invention to provide a rapid exhaust valve for railway vehicles that discharges pressure air from an automatic door opening/closing gear of a railway vehicle to allow manual operation of an automatic door, the exhaust valve being made compact in overall size while giving an exhaust outlet a large bore diameter to reduce a venting time to keep it within a given time, showing superior operability to certainly prevent leakage at channel switching, allowing a change in a piping direction and an operation direction according to an installation location while keeping the number of components small, and switching a channel to allow rapid venting from a desired pipeline, and to provide a piping system of a railway vehicle which piping system uses the exhaust valve.

### Means for Solving the Problems

In order to solve the above problems, an invention according to claim 1 provides a rapid exhaust valve for railway vehicles in which exhaust valve outflow/inflow ports and an exhaust outlet are formed on a valve element housing portion having a spherical surface portion, the valve element housing portion being formed on a part of the inner periphery of a body. A valve element having a spherical surface portion is inserted rotatably in the valve element housing portion through an opening formed on the valve element housing portion, the valve element having a plurality of through-holes communicating with the outflow/inflow ports or the exhaust outlet and a fitting slot counter to the outflow/inflow ports that is formed in a direction crossing the through-holes. When a seal that closes the outflow/inflow ports or the exhaust outlet is fitted in the fitting slot and the opening is closed with a lid, the seal seals up any one of the outflow/inflow ports or the exhaust outlet to allow the outflow/inflow port and the exhaust outlet or one outflow/inflow port and another outflow/inflow port to communicate with each other through the through-holes, and the area of the exhaust outlet is adjusted properly to be able to determine a venting time required for venting from a pipeline for an automatic door opening/closing gear in an emergency situation or during maintenance work to be a given time.

The invention according to claim 2 provides the rapid exhaust valve for railway vehicles in which exhaust valve a holding ring is interposed between the lower inner peripheral surface of the valve element housing portion and the lower outer peripheral surface of the valve element.

The invention according to claim 3 provides the rapid exhaust valve for railway vehicles in which exhaust valve a mechanism that adjusts the area of the exhaust outlet is an exhaust orifice formed in the exhaust outlet.

The invention according to claim 4 provides the rapid exhaust valve for railway vehicles in which exhaust valve the exhaust outlet is almost identical in bore diameter with the outflow/inflow port.

The invention according to claim 5 provides the rapid exhaust valve for railway vehicles in which exhaust valve a spring is disposed between the lid and the valve element and the seal can be fastened further with the lid closing the opening, via the spring.

The invention according to claim 6 provides the rapid exhaust valve for railway vehicles in which exhaust valve a nozzle capable of changing a venting direction is fitted in the exhaust outlet.

The invention according to claim 7 provides the rapid exhaust valve for railway vehicles in which exhaust valve a dustproofing cap that prevents entry of a foreign object into the valve is connected to the body, the cap in its connected state opening the exhaust outlet when subjected to the pressure of discharged air in exhaust mode while returning to a closing position to close the exhaust outlet in non-exhaust mode.

The invention according to claim 8 provides the rapid exhaust valve for railway vehicles in which exhaust valve the exhaust outlet is fitted with a muffler that reduces an exhaust sound.

The invention according to claim 9 provides the rapid exhaust valve for railway vehicles in which exhaust valve the exhaust outlet is fitted with a check valve capable of opening in a venting direction, which check valve prevents entry of an extraneous foreign object or water into the exhaust outlet.

The invention according to claim 10 provides a rapid exhaust valve for railway vehicles in which exhaust valve a valve element housing portion having a spherical surface portion is formed on a part of the inner periphery of a body having at least three or more outflow/inflow ports. A valve element having a spherical surface portion is inserted rotatably in the valve element housing portion through an opening formed on the valve element housing portion, the valve element having three or more through-holes communicating with the outflow/inflow ports and a fitting slot counter to the outflow/inflow ports that is formed in a direction crossing the through-holes. A seal that closes the outflow/inflow ports is fitted in the fitting slot, the opening is closed with a lid that can be tightened further, and the resilient force of a spring disposed between the lid and the valve element causes the seal to seal up any one of the through-holes.

The invention according to claim 11 provides the rapid exhaust valve for railway vehicles in which exhaust valve an upper stem formed on the valve element is fitted pivotally in a fitting hole formed on the body, via a seal, while a lower stem set opposite to the upper stem of the valve element is fitted in a fitting hole formed on the lid, via a seal to pivotally support the valve element between the body and the lid, thereby improve torque performance.

The invention according to claim 12 provides the rapid exhaust valve for railway vehicles in which exhaust valve the upper stem and lower stem are formed such that their shaft diameters are almost the same to apply an equal pressure.

The invention according to claim 13 provides the rapid exhaust valve for railway vehicles in which exhaust valve the outflow/inflow ports are formed at 90 degrees intervals on the body such that an outflow/inflow port between two inline outflow/inflow ports serves as an exhaust outlet and that the directions of the two outflow/inflow ports are switched to reverse the direction of the exhaust outlet at 180 degrees. An operating handle having a stopper for regulating rotation is attached to the upper stem such that the operating handle can be set in arbitrary directions at 90 degrees intervals via an almost cross-shaped fitting hole, and mounting holes are formed at 90 degrees intervals at positions on the body at which the stopper is locked. A locking pin allowing the stopper to be locked thereon is inserted in any one of the mounting holes to allow the handle to be shifted in an arbitrary opening/closing operation direction.

The invention according to claim 14 provides the rapid exhaust valve for railway vehicles in which exhaust valve the lid is screwed into the opening via an O-ring such that the pressing force of the spring to the seal of the valve element can be adjusted by adjusting screwing of the lid.

The invention according to claim 15 provides a piping system of a railway vehicle in which system a plurality of the rapid exhaust valves for railway vehicles are arranged in the middle of a main pipe and a branch pipe or a pipeline branch section making up air piping that drives an automatic door opening/closing gear of a railway vehicle and a variation in the venting time of each rapid exhaust valve is prevented to keep the venting time constant.

The invention according to claim 16 provides the piping system of the railway vehicle in which system the rapid exhaust valve for railway vehicles is disposed in the middle of pressure piping for door opening that is provided inside or outside a railway vehicle.

### Effects of the Invention

According to the invention of claim 1, the exhaust valve is provided, which can rapidly discharges pressure air from the automatic door opening/closing gear of the railway vehicle to allow manual operation of the automatic door. According to the exhaust valve, the valve element having the spherical surface portion is inserted in the valve element housing portion having the spherical portion formed on its part. This allows the bore diameter of the channel to be increased to a full-bore diameter while securing the overall compactness of the valve, thereby ensures a large flow rate at channel switching by the rotation of the valve element and a large exhaust volume at venting, and allows the area of the exhaust outlet to be properly adjusted to be able to keep the venting time constant, the venting time varying due to a change in a piping capacity for venting caused by a change in the location of installation of the exhaust valve in piping, thereby reduces the venting time to a short time within a given time. As a result, a time taken from a point of operation of the valve to a point of manual operation of the automatic door can be set short, which allows quick manual operation of the door in an emergency situation or during maintenance work. In addition, a body can be made into the one-piece structure, in which case components do not loosen during piping work, air leakage from piping is certainly prevented, and the valve as a whole is miniaturized by reducing the number of components and therefore can be disposed in a narrow space inside or outside the railway vehicle.

According to the invention of claim 2, the inner and outer diameters of the holding ring secure the axis of the spherical seal surface of the body and the rotation axis of the valve element while eliminating the unevenness of the surface pressure of the seal caused by a fluid pressure. This improves the opening/closing operation performance and sealing performance of the exhaust valve.

According to the invention of claim 3, a pressure air discharge time can be properly adjusted for each valve. As a result, the size of the exhaust outlet can be determined from outside to be a size for a necessary exhaust volume to be able to adjust the venting time for venting from pressure piping to a short time, without being affected by the capacity of the pressure piping varying depending on the type of the railway vehicle and by the location of the valve installed in piping inside or outside the railway vehicle.

According to the invention of claim 4, the exhaust outlet is formed to be almost identical in bore diameter with the outflow/inflow port. This reduces the loss of venting from the exhaust outlet to the minimum, thereby achieves efficient discharge of pressure air, thus reducing the venting time.

According to the invention of claim 5, an operation torque is kept low by adjusting further tightening of the lid to allow a smooth operation as the seal fitted in the fitting slot of the valve element is pressed by the resilient force of the spring to seal up the outflow/inflow port or the exhaust outlet. As a result, even when the size of the seal changes as a result of its expansion/contraction caused by its abrasion during sliding movement or a temperature change resulting from an ambient temperature change, the seal is caused to follow the fitting slot to ensure its sealing performance, which allows the channel to be switched as leakage is prevented.

According to the invention of claim 6, the venting direction can be set freely. A proper venting direction, therefore, can be set according to the state and location of piping in the railway vehicle and a piping condition/environment around the valve as discharge of pressure air toward an operator is avoided. Hence the valve is incorporated in pressure piping required to be laid in a limited piping space inside and outside the railway vehicle as the venting direction of the valve is set properly. This contributes to space-saving for the entire piping.

According to the invention of claim 7, the dustproofing cap puts the exhaust outlet in an open state in venting mode to allow smooth venting while preventing entry of an extraneous foreign object in non-venting mode, thus preventing a drop in such functional performances as channel switching performance and sealing performance.

According to the invention of claim 8, by discharging pressure air through the muffler, noise in venting mode is reduced.

According to the invention of claim 9, in non-venting mode, entry of an extraneous foreign object, such as dust, and water in the valve or piping is prevented to protect the seal while one outflow/inflow port and another outflow/inflow port are connected communicatively with each other. In venting mode, venting is performed so that residual pressure air on the secondary side flows out smoothly to the outside.

According to the invention of claim 10, the valve element having the spherical surface portion is inserted in the vale element housing portion having the spherical surface portion on its part. This allows venting to be performed through the valve outflow/inflow port switching as the channel diameter is increased to the full-bore diameter to ensure a large flow rate and allows the venting time to be reduced because of a large exhaust volume at channel switching. In addition, the body can be made into the one-piece structure, in which case components do not loosen during piping work, air leakage from piping is certainly prevented, and the valve as a whole is miniaturized by reducing the number of components and therefore the compact valve can be disposed in a narrow space inside or outside the railway vehicle. The opening is closed with the lid that can be tightened further, and the seal is made into a single seat structure. This allows smooth operation to be carried out while the operation torque is kept low. Anyone of the through-holes is sealed up with the seal fitted in the fitting slot of the vale element, by pressing the valve element by the resilient force of the spring. This causes the seal that expands/contacts due to a change in the temperature of pressure air resulting from an ambient temperature change to follow the fitting slot, thus ensuring the seal's sealing performance to allow channel switching while preventing leakage. Because the direction of installation and operation of the handle can be set freely, the direction of the exhaust outlet and of the handle is set according to any given location to enable simple and quick air discharge and component replacement as the body is connected to piping.

Because of these advantages, the valve as a whole is compactified as high flow rate characteristics and sealing performance are ensured. As a result, even when air piping needs a great number of channel switching sections, air can be discharged through the exhaust outlet by operating the handle unforcibly while preventing malfunctioning. Hence a rotary valve preferable for switching the channel of the air piping of the railway vehicle can be provided.

According to the invention of claim 11, the valve element is pivotally supported between the body and the lid by the upper stem and the lower stem to improve the torque performance. This trunnion structure prevents the displacement of the valve element by any air pressure, maintains the sealing performance against an air pressure from the primary side and the secondary side by using the resilient force of the spring, and ensures superior operability to allow quick channel switching with a light operating force.

According to the invention of claim 12, the upper stem and the lower stem are so formed such that their shaft diameters are almost the same to give the valve element an equal pressure. This offsets a pressure thrust created by a fluid pressure in the body, thereby reduces the operation torque of the valve element to an abrasive toque created as a result the sliding move of the seal inside the body. Hence the operation torque of the valve is reduced to allow the valve to be easily operated manually.

According to the invention of claim 13, the insertion position of the locking pin is changed when one body and one handle are used. This allows different combinations of the direction of the exhaust outlet to the outflow/inflow ports and the direction of the handle and its operation in valve closed mode and valve-open mode. The locking piece is locked on the stopper to prevent its malfunctioning as its superior operability is ensured. Hence a plurality of valves whose installation locations and directions are varied may be installed in a narrow piping space without requiring various bodies, handles, and handle locking stoppers.

According to the invention of claim 14, the upper and lower position of the valve element can be adjusted by screwing the lid. Rotating the lid in the direction of pressing the valve element to the spherical surface portion of the body, therefore, strengthens the pressure bonding of the seal to improve its sealing performance. Rotating the lid in the direction reverse to the direction of pressing the valve element, on the other hand, weakens the pressure bonding of the seal to suppress its wearing. In this structure, the durability of the seal is enhanced to extend its lifespan through minor adjustment of the sealing surface pressure of the seal, so that sliding resistance during operations is suppressed to improved operability.

According to the invention of claim 15, pressure air inside the automatic door opening/closing gear of the railway vehicle can be discharged rapidly in a short venting time within a given time to allow quick manual operation of the automatic door, in which case the channel can be changed to rapidly discharge air through a pipeline in a desired area. In the same railway vehicle, the area of the exhaust outlet of each rapid exhaust valve installed in the railway vehicle is changed to keep the venting time in the given area within the given time. In the case of different types of railway vehicles or different piping conditions, the rapid exhaust valves are arranged in a proper location in piping, where the area of the exhaust outlet of each rapid exhaust valve is adjusted to allow venting in the given time, which allows the automatic door opening/closing gear to be opened and closed manually.

According to the invention of claim 16, the rapid exhaust valve can be installed in each location inside or outside the railway vehicle. In an emergency situation or during maintenance work, therefore, the rapid exhaust valve installed nearby is operated to carry out venting in a desired area.

### BRIEF DESCRIPTION OF DRAWINGS

FIG. 1 is a perspective view showing a rapid exhaust valve for railway vehicles according to a first embodiment of the present invention;

FIG. 2 is a vertically expanded sectional view of the rapid exhaust valve of FIG. 1;

FIGS. 3(a), 3(b), and 3(c) are sectionals views showing a state of rotation of a valve element according to the first embodiment;

FIG. 4 is a plan view showing a handle for manual operation;

FIG. 5 is a perspective view showing a nozzle;

FIGS. 6(a) and 6(b) are principle part sectional views showing states of connection of an elbow pipe;

FIG. 7 is a principle part sectional view showing a state of attachment of a muffler;

FIG. 8 is a principle part sectional view showing a state of attachment of a check valve;

FIGS. 9(a) and 9(b) are sectional views showing another example of the rapid exhaust valve for railway vehicles;

FIG. 10 is a schematic diagrammatical view showing an embodiment of a piping system of a railway vehicle;

FIG. 11 is a schematic diagrammatical view showing a first venting state of the piping system of FIG. 10;

FIG. 12 is a schematic diagrammatical view showing a second venting state of the piping system of FIG. 10;

FIG. 13 is a schematic diagrammatical view showing a third venting state of the piping system of FIG. 10;

FIG. 14 is a schematic diagrammatical view showing a fourth venting state of the piping system of FIG. 10;

FIG. 15 is a schematic diagrammatical view showing another example of the piping system;

FIG. 16(a) is a perspective view of another embodiment of the handle for manual operation, and FIG. (b) and (c) are perspective views showing the handle for manual operation attached to a rapid exhaust valve for railway vehicles according to a second embodiment of the present invention;

FIGS. 17(a), 17(b), and 17(c) are sectional views showing a state of rotation of a valve element according to the second embodiment;

FIG. 18 is a perspective view of a fully opened state of a rapid exhaust valve for railway vehicles according to a third embodiment of the present invention;

FIG. 19 is a sectional view taken along an A-A line of FIG. 18;

FIG. 20 is a sectional view taken along an B-B line of FIG. 18;

FIG. 21 is a perspective view showing the handle for manual operation attached to the rapid exhaust valve for railway vehicles of the third embodiment shown in FIG. 18; and

FIG. 22 depicts another example of the rapid exhaust valve of FIG. 18, presenting a sectional view along the A-A line that indicates a state of venting by the exhaust valve.

### EXPLANATION OF LETTERS OR NUMERALS

1 Valve main body
   2 Body
3 Valve element
4 Lid
5 Seal
8 Orifice
9 Holding ring
9a Fitting inner peripheral surface
9b Fitting step
9′ Thrust washer
10, 11 Outflow/inflow port
12 Exhaust outlet
15 Spherical surface portion
16 Valve housing portion
22 Opening
28 Spherical surface portion
30, 31, 32 Through-hole
33 Fitting slot
70 Railway vehicle
71 Air piping (pressure piping)
80 Nozzle
90 Dustproofing cap
100 Muffler
110 Check valve
120 Automatic door opening/closing gear
141 Main pipe
142 Brach pipe
143 Pipeline branch section
S Area of the exhaust outlet

### BEST MODES FOR CARRYING OUT THE INVENTION

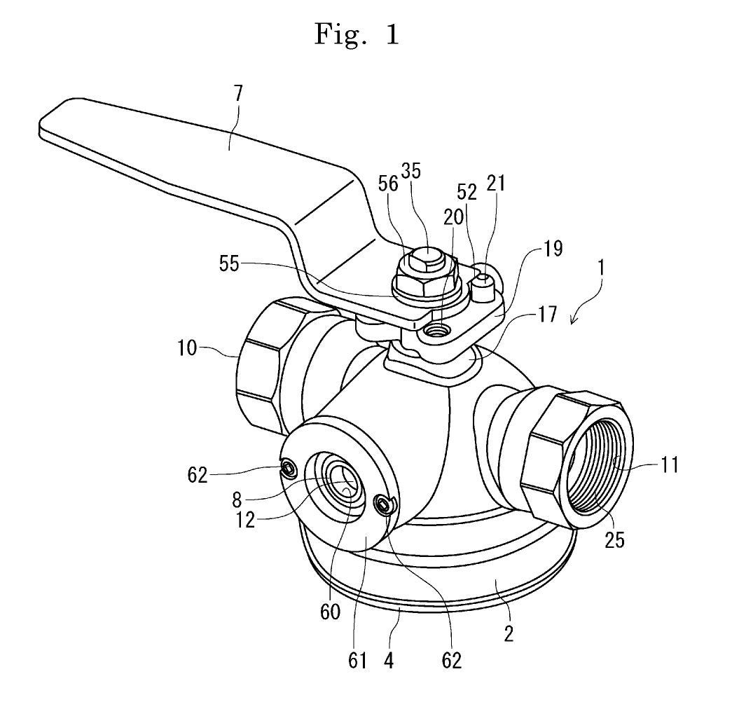

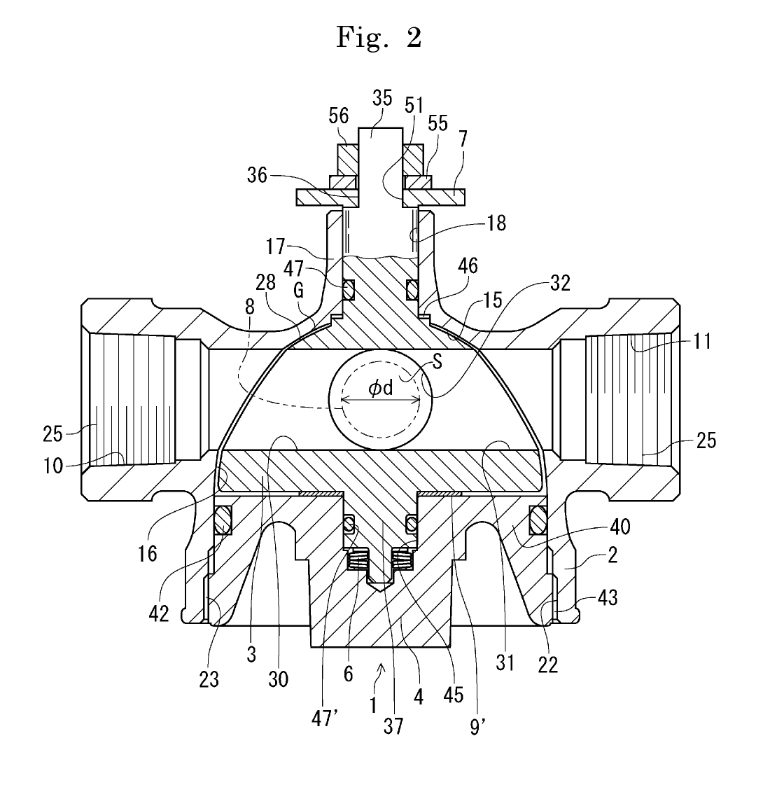

Embodiments of a rapid exhaust valve for railway vehicles and a piping system of a railway vehicle according to the present invention will hereinafter be described in detail with reference to drawings. FIG. 1 is a perspective view of a rapid exhaust valve for railway vehicles according to a first embodiment of the present invention, and FIG. 2 is a vertically expanded sectional view of the rapid exhaust valve of FIG. 1. The rapid exhaust valve for railway vehicles according to the present invention (hereinafter, referred to as “valve main body 1”) includes a body 2, a valve element 3, a lid 4, a seal 5, a spring 6, which is a disc spring, a manually operated handle 7, and an exhaust orifice 8.

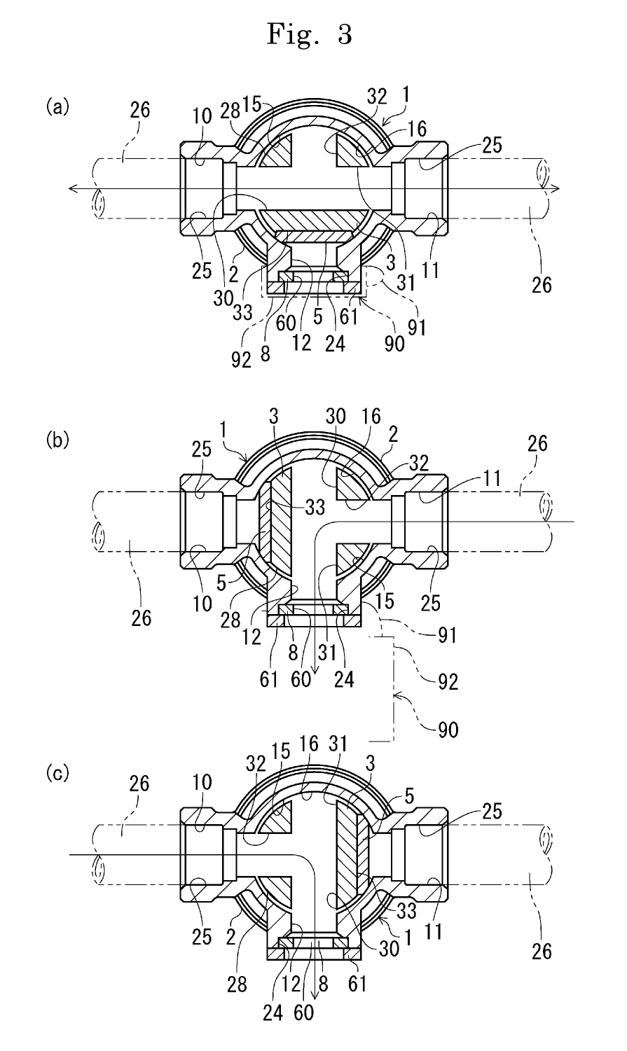

In FIG. 2, the body 2 of the valve main body 1 is made of such materials as bronze, brass and stainless and is formed into a one-piece structure. The body 2 has outflow/inflow ports 10 and 11 and an exhaust outlet 12 crossing the outflow/inflow ports 10 and 11. In this example, as shown in FIG. 3, the exhaust outlet 12 is formed between two inline outflow/inflow ports 10 and 11 such that the exhaust outlet 12 makes a 90 degrees angle with each of the inline outflow/inflow ports 10 and 11. Because of such an overall shape of the body 2, the valve main body 1 can be installed in piping such that the direction of the exhaust outlet 12 can be reversed at 180 degrees by switching the direction of the two inline outflow/inflow ports 10 and 11.

On a part of the inner periphery of the body 2, a valve element housing portion 16 having a spherical surface portion 15 is formed. On the upper part of the valve element housing portion 16, a shaft-fitting portion 17 is formed, inside of which a fitting hole 18 is formed. A flange 19 is formed on top of the shaft-fitting portion 17. The flange 19 has mounting holes 20 formed at four spots at 90 degrees intervals, and a locking pin 21 is inserted in any one of the mounting holes 20 by press fitting or screwing the locking pin 21. On the lower part of the valve element housing portion 16, an opening 22 is formed, on which a female screw 23 is formed. The spherical surface portion 15 is shaped into an approximate hemispheric concave by spot-facing an approximate hemisphere.

The exhaust outlet 12 is almost identical in bore diameter with the outflow/inflow ports 10 and 11 and is formed to be in communication with the valve element housing portion 16 in the same manner as the outflow/inflow ports 10 and 11. The exhaust outlet 12 is formed as a through-hole having a diameter of, for example, 12 mm. On the periphery of the exhaust outlet 12, a spot-facing portion 24 of 15 mm in diameter is formed. Each of the outflow/inflow ports 10 and 11 has a screw portion 25 formed on its inner periphery as a female screw portion. A pipe 26 can be connected to each of the outflow/inflow ports 10 and 11 via the screw portion 25.

The valve element 3 is inserted in the valve element housing portion 16 through the opening 22 of the body 2 and is set rotatable in a vertically positioned state. The vale element 3 has a spherical surface portion 28 formed on its part. According to this embodiment, the outer peripheral surface of the valve element 3 is formed as the surface of the spherical surface portion 28 of a hemispherical shape.

In FIG. 3, on the outer peripheral surface of the spherical surface portion 28, through-holes 30, 31, and 32 are formed in three directions, respectively, which can communicate with the outflow/inflow ports 10 and 11 or the exhaust outlet 12. In a lateral direction crossing the through-holes 30, 31, and 32, a fitting slot 33 is formed, which can be set counter to the outflow/inflow ports 10 and 11 or the exhaust outlet 12. In the fitting slot 33, the elastic seal 5 is fitted removably, which can close up the outflow/inflow ports 10 and 11 or the exhaust outlet 12. According to this embodiment, the fitting slot 33 is a circular slot, so that the seal 5 is made into a disc shape that can be fitted in this circular slot 33. The through-holes may be formed in four or more directions, respectively, and the outflow/inflow ports and exhaust outlet may also be formed in four or more directions, respectively. In such a case, which is not depicted, the through-holes as well as the outflow/inflow ports and exhaust outlet make angles of smaller than 90 degrees with each other.

The through-holes 30, 31, and 32 are each formed as a full-bore type through-hole with a diameter almost the same as that of the outflow/inflow ports 10 and 11 or the exhaust outlet 12. Because of this structure, the through-holes 30, 31, and 32 incur less pressure loss when connected communicatively with the outflow/inflow ports 10 and 11 or the exhaust outlet 12. Each of the through-holes 30, 31, and 32 may be provided as a through-hole different from the full-bore type through-hole, such as a standard-bore type through-hole whose channel diameter is made smaller than that of the full-bore type by one degree of size (diameter reduction) and a reduced-bore type through-hole, i.e., through-hole with a narrower bore diameter, whose channel diameter is made smaller than that of the full-bore type by two degree of size. The full-bore type is capable of suppressing pressure loss more effectively than other types, thus offering improved flow rate characteristics.

In FIGS. 1 and 2, an upper stem 35, to which a handle 7 can be attached, is formed on the top of the valve element 3 as a stem integral to or separated from the valve element 3. A fitting projection 36 is formed on the handle attachment position of the upper stem 35. A lower stem 37 is formed opposite to the upper stem 35, as a stem integral to the valve element 3. The upper stem 35 and lower stem 37 are so formed as to have shaft diameters almost equal to each other so that an equal pressure by in-piping air is applied to the valve element 3.

The valve element 3 has a shape that can be fitted in the spherical surface portion 15. In this case, the portion equivalent to the spherical surface portion 28 may be made into a shape other than the hemispheric shape on the condition that a channel can be switched by rotating the through-holes 30, 31, and 32 and the seal 5 to set them counter to the outflow/inflow ports 10 and 11 or the exhaust outlet 12. A gap G is formed between the spherical surface portion 28 and the spherical surface portion 15, and the size of this gap G is adjusted by adjusting the rotation of the lid 4 to regulate an extent of further tightening of the valve element 3.

The seal 5 fitted to the valve element 3 is made of, for example, a polymer material, such as PTFE (Polytetrafluoroethylen) and PTFE containing a carbon fiber. When the valve element 3 is rotated, the seal 5 is rotated together with the valve element 3 to be able to seal each of the outflow/inflow ports 10 and 11 or the exhaust outlet 12. When the seal 5 is shifted from the outflow/inflow ports 10 and 11 or the exhaust outlet 12, a fluid is allowed to flow through the outflow/inflow ports 10 and 11 or the exhaust outlet 12.

The lid 4 is made into a shape capable of closing the opening 22, and has a column portion 40 formed on the upper outer periphery of the lid 4. The column portion 40 has an outer diameter that allows the column portion 40 to be fitted in the opening 22 of the body 2, and has an O-ring 42 fitted on the outer periphery of the column portion 40. On the lower outer periphery of the column portion 40, a male screw 43 is formed, which can be screw-engaged with the female screw 23 of the body 2. Through these male screw 43 and female screw 23, the opening 22 is closed with the lid 4 via the spring 6, which will be described later, in a condition where the valve element 3 can be further tightened. A fitting hole 45 is formed at the center of the part of lid 4 that is closer to the valve element 3. The part between the fitting hole 45 and the column portion 40 is reduced in thickness to reduce the total weight of the lid 4. In FIG. 2, the lid 4 is made small in height, which makes the valve main body 1 small in height as a whole.

The vale element 3 is structured such that the upper stem 35 is fitted pivotally in the fitting hole 18 of the body 2 via a sealing material 47, which is an O-ring, while the lower stem 37 is fitted pivotally in the fitting hole 45 of the lid 4 via a sealing material 47′, thus having a trunnion structure pivotally supported between the body 2 and the lid 4. A gape dimension 46 is formed between the upper stem 35 and the body 2.

The valve element 3 can be opened and closed using the handle 7 attached to the upper part of the upper stem 35. The spring 6 having upper/lower faces made of disc springs is interposed between the lower stem 37 of the valve element 3 and the fitting hole 45 of the lid 4. The spring 6 exerts its resilient force to push the seal 5, causing the seal 5 to seal up any one of the outflow/inflow ports 10 and 11 and the exhaust outlet 12, in which state the outflow/inflow ports 10 and 11 and the exhaust outlet 12 or the outflow/inflow port 10 and the outflow/inflow port 11 can communicate with each other via the through-holes 30, 31 and 32.

In FIGS. 1 to 3, the exhaust orifice 8 has an outer diameter that allows the orifice 8 to be housed in the spot-facing portion 24 of the exhaust outlet 12. At the center of the orifice 8, a communication hole 60 is bored, which has a bore diameter Φd shown FIG. 2 that is determined to be, for example, any one of 6 mm, 8 mm, and 10 mm. The orifice 8 housed in the spot-facing portion 24 is covered with an annual cover 61, which is screw-fastened and fixed to the body 2 with screws 62. In this configuration, when the orifice 8 is attached to the exhaust outlet 12, the bore diameter of the exhaust outlet 12 is reduced to any one of 6 mm, 8 mm, and 10 mm, and when the orifice 8 is removed, pressure air is discharged through the exhaust outlet 12 having a bore diameter of 12 mm. When the exhaust outlet 12 having the bore diameter of 12 mm is used, therefore, the orifice 8 and cover 61 are unnecessary. Female screws of the cover 61 are formed, for example, at four spots of the body at 90 degrees intervals, which is not depicted.

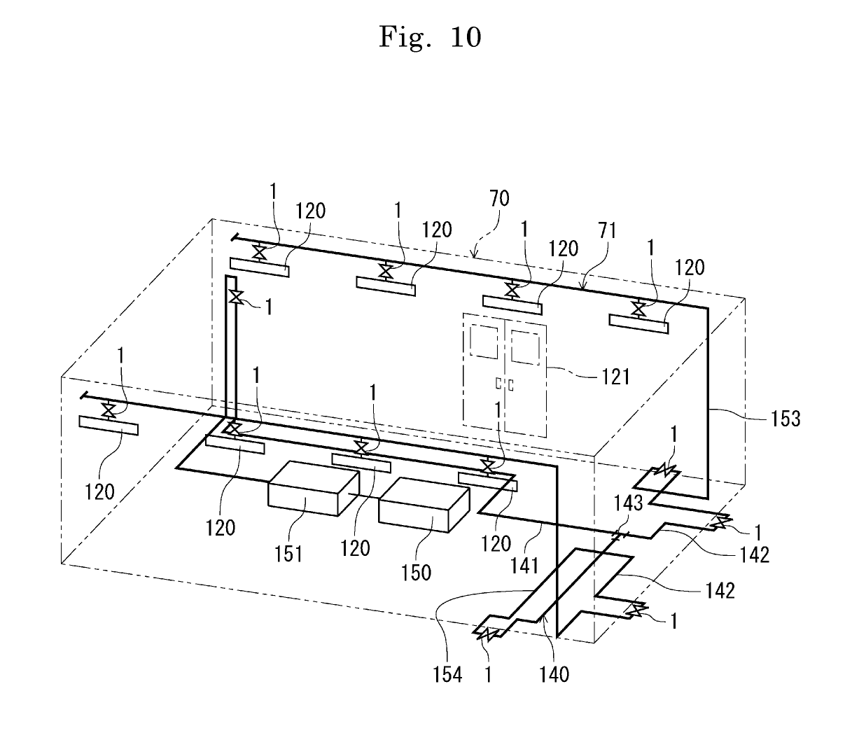

When the bore diameter of the exhaust outlet 12 is determined to be each orifice bore diameter as described above, each orifice bore diameter can be set in a condition where the valve main body 1 is installed in piping of a railway vehicle 70 shown in FIG. 10. By attaching or removing the orifice 8, therefore, a proper exhaust outlet diameter can be selected for the same valve. Through selection of the exhaust outlet diameter, the orifice 8 serves as a mechanism that can properly adjust the area of exhaust outlet S indicated by a two-dot chain line in FIG. 2. By adjusting the area of exhaust outlet S, a venting time required for venting from pressure piping for railway vehicles (air piping) 71 in an emergency situation or during maintenance work can be set constant.

The area of exhaust outlet S is given by an equation: S=(πΦd²)/4(Φd denotes the bore diameter). When the bore diameter of the orifice 8 is 6 mm, 8 mm, and 10 mm, therefore, the area of exhaust outlet S is about 28.27 mm², 50.27 mm², and 78.54 mm², respectively. When the bore diameter of the exhaust outlet 12 is 12 mm, on the other hand, the area of exhaust outlet S is about 113.10 mm².

In FIG. 2, through engagement between the male screw 43 and the female screw 23, the lid 4 is screw-fastened to the opening 22 via the O-ring 42 such that the lid 4 proceeds toward and retreats from the body 2 freely. By adjusting screwing of the lid 4, the pressing force of the spring 6 applied to the seal 5 is adjusted. When the lid 4 is screwed in toward the body 2, the spring 6 is compressed, in which case the spring force of the spring 6 pushes the valve element 3 inward, increasing the adhesion between the seal 5 and the spherical surface portion 15, thus ensuring a primary back pressure (bi-flow) sealing performance. The spring 6 absorbs dimensional errors of the body 2 and valve element 3 and allows the valve element 3 to be set in place in the valve element housing portion 16. The spring 6 may be provided as a spring other than the disc spring on the condition that such a spring has elasticity.

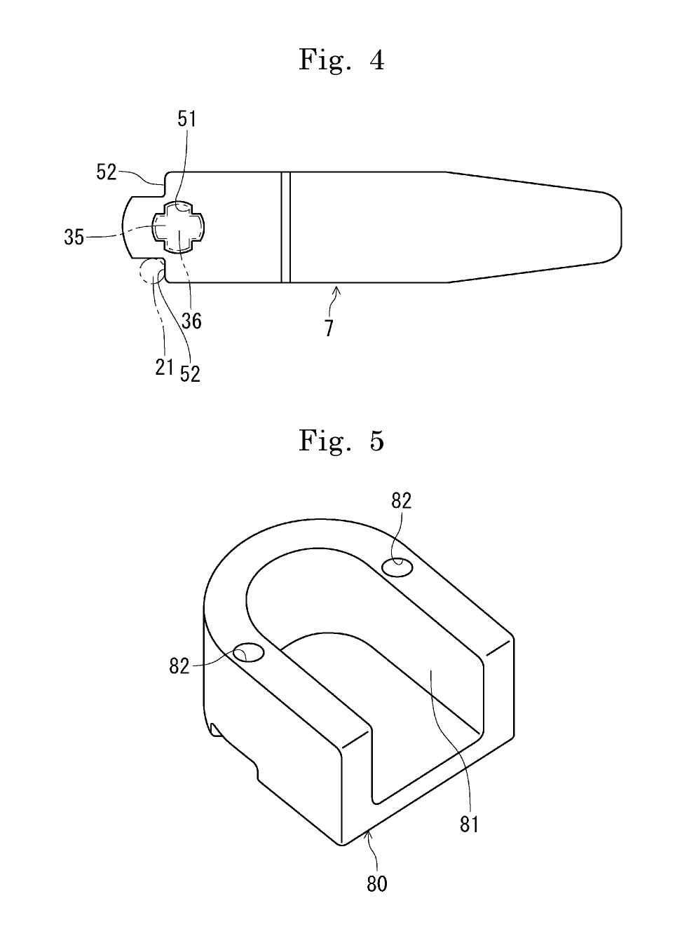

The handle 7 shown in FIG. 4 is provided with an almost cross-shaped fitting hole 51 in which the fitting projection 36 can be fitted. The handle 7 is attached to the upper stem 35 via the fitting hole 51 such that the handle 7 can be attached in arbitrary directions at 90 degrees intervals. In this case, each of the fitting hole 51 and the fitting projection 36 may have a shape other than a cross shape on the condition that the handle 7 can be attached to the upper stem 35 in arbitrary directions at 90 degrees intervals. The handle 7 has stopper portions 52 formed as cutouts. The stopper portion 52 comes in contact with a locking pin 21 inserted in any one of four mounting holes 20 and is locked on the locking pin 21. Hence, as the direction of the handle 7 and of its operation is set, the handle 7 is rotated in an arbitrary operation direction at 90 degrees to change the channel.

A nozzle 80 shown in FIG. 5 can be attached to the exhaust outlet 12 of the valve main body 1 configured in the above manner. Inside the nozzle 80, an exhaust slot 81 through which the exhaust outlet 12 can communicate with the outside is formed. At two spots of the outer peripheral edge of the nozzle, two through-holes 82 are formed for inserting the screws 62 therein, so that the nozzle 80 can be fixed to the exhaust outlet 12 with the screws 62, via the through-holes 82. As described above, four female screws are formed on the body 2. By setting the exhaust slot 81 in a desired direction and screw-fastening the nozzle 80 having the through-holes 82 matched to the female screws, the direction of pressure air coming out of the exhaust outlet 12 can be changed. In addition, if the number of the female screws is increased, the direction of the exhaust outlet 12 can be set in a more elaborate manner.

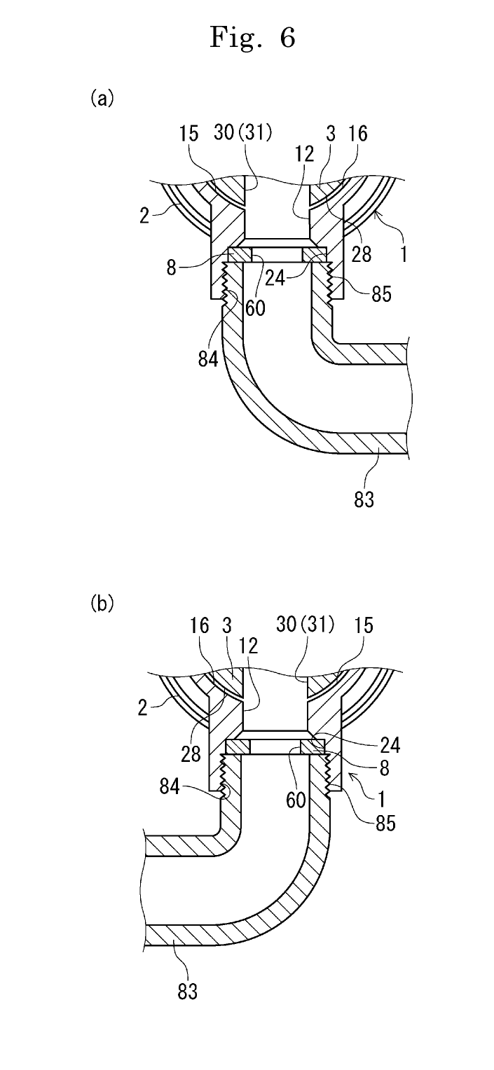

FIG. 6 depicts states of connection of an elbow pipe 83 to the exhaust outlet 12 of the valve main body 1. In this case, a female screw portion 84 is formed on the end of the exhaust outlet 12, and a male screw portion 85 formed on the elbow pipe 83 can be screw-engaged with the female screw portion 84. When the male screw portion 85 and female screw portion 84 are engaged, the venting direction of the elbow pipe 83 may be changed freely by changing an extent of screw-in, as shown in FIGS. 6(a) and 6(b). In this case, as in the same manner in the case of providing the nozzle 80, the direction of venting may be set as the orifice 8 having the communication hole 60 with the proper bore diameter Φd is housed in the spot facing portion 24. The area of exhaust outlet S may be adjusted by connecting an air joint, which is not depicted, to the exhaust outlet 12.

As indicated in FIG. 3(a) by a two-dot chain line, the exhaust outlet 12 may be provided with a dustproofing cap 90, which prevents a foreign object from entering the valve main body 1 through the exhaust outlet 12. The dustproofing cap 90 has an annular connecting portion 91 that can be connected to the body 2. This connecting portion 91 prevents a cap body 92 connected to the connecting portion 91 from dropping off the body 2. In FIG. 3 (b), when pressure air is discharged from the exhaust outlet 12, the cap body 92 is removed from the exhaust outlet 12 by the pressure of air discharged from the exhaust outlet 12 while being kept connected to the body 2 through the connecting portion 91, thus leaving the exhaust outlet 12 open. When pressure air is not discharged, on the other hand, the cap body 92 is attached to the exhaust outlet 12 in a state indicated in FIG. 3 (a), thus putting the exhaust outlet 12 back into its closed state.

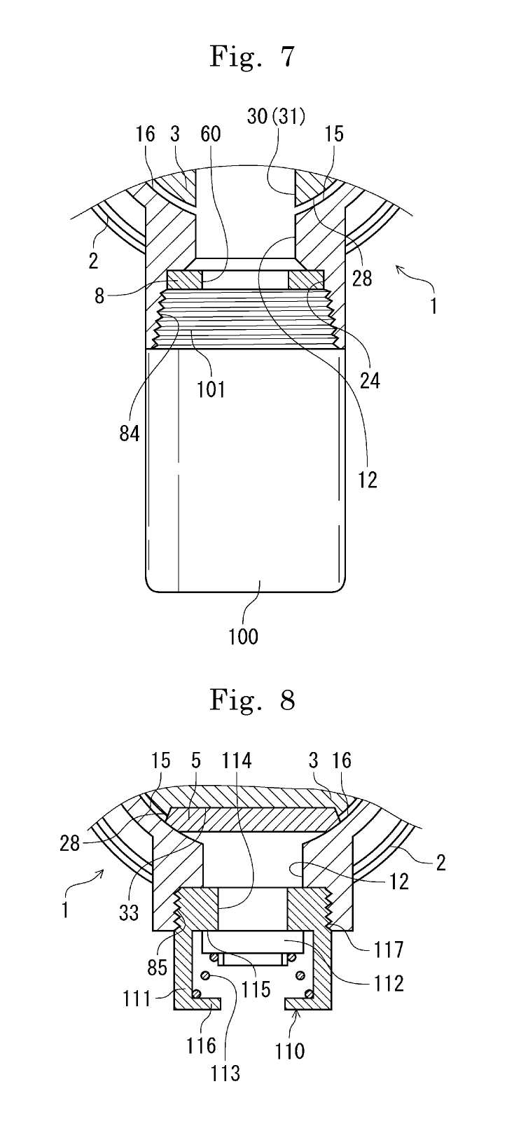

FIG. 7 depicts a state of attachment of a muffler 100 to the valve main body 1. The muffler 100 has a male screw portion 101 screw-engaged with the female screw portion 84 and is therefore screwed into the exhaust outlet 12 by screw-engaging the screw portion 101 with the female screw portion 84. Any commercially sold air muffler can be used as the muffler 100, whose internal structure is therefore not limited to a specific structure. Attaching the muffler 100 reduces an exhaust sound from the valve main body 1 when pressure air is discharged.

FIG. 8 depicts a state of attachment of a check valve 110 to the valve main body 1. The check valve 110 has a so-called lift check valve structure, and includes a body 111, a check valve element 112, and a spring 113. The body 111 is almost cylindrical, and has a communication hole 114 communicating with the exhaust outlet 12, a valve seat 115 on which the check valve element 112 sits, an annular locking portion 116 that locks one end of the spring 113, and a male screw 117 screw-engaged with a female screw portion 85. The check valve element 112 is attached to the valve main body 1 such that the check valve element 112 is kept pushed toward the valve seat 115 by the spring 113 locked to the locking portion 116.

In ordinary mode (non-venting mode), as shown in FIG. 8, the seal 5 seals up the exhaust outlet 12, which puts the primary side of the check valve 110 in a pressureless state. The check valve 112 is thus sat on the valve seat 115 by the resilient force of the spring 113.

In this state, when the valve element 3 is rotated to locate the seal 5 on the primary side of piping, thus creating venting mode, residual air on the secondary side pushes the check valve element 112 open against the resilient force of the spring 113, which causes pressure air to escape to the outside. In this manner, fitting the exhaust outlet 12 with the check valve 110 that opens in the venting direction prevents entry of extraneous foreign object or water in the exhaust outlet 12.

When the valve main body 1 is attached, the orifice 8 is housed first in the spot-facing portion 24 of the body 2, and the cover 61 is fixed from above the orifice 8 with the screws 62 to attach the orifice 8 to the body 2. Meanwhile, the seal 5 and the sealing materials 47 and 47′ are attached to the valve element 3, which is put through the opening 22 into the valve element housing portion 16 of the spherical surface portion 15, from below the body 2, after which the upper stem 35 is inserted in the fitting hole 18. At this time, the seal 5 is in contact with the body 2 with no pressing force acting on the seal 5.

Subsequently, the spring 6 composed of the disc spring is fitted in the fitting slot 45 of the lid 4, and as the lower stem 37 is inserted in the fitting hole 45, the lid 4 is fitted together with the body 2 from below by screw-engaging the male screw 43 with the female screw 23. The valve element 3 is thus pressed with the lid 4 via a thrust washer 9′. At this time, the lid 4 is tightened and loosened using a general-purpose tool, such as socket wrench (not depicted), to adjust an extent of tightening of the lid 4, through which adjustment the lid 4 is fitted to the body 2 as the pressing force of the spring 6 to the seal 5 is kept proper. In addition, by adjusting the extent of tightening of the lid 4 as the valve main body 1 is installed in piping, air leakage from the seal 5 due to its deterioration can be remedied.

According to this embodiment, a so-called bottom entry structure is employed, in which the valve element 3 is fitted to the body 2 from below. Because of this structure, the position of the valve element 3 to the body 2 is adjusted by the lid 4, and the valve element 3 can be fitted easily in place in the vale element housing portion 16 as the dimensional errors of the body 2 and valve element 3 are absorbed. The valve main body 1, however, may be formed into a top entry structure in which the valve element 3 is fitted to the body 2 from above.

Subsequently, the locking pin 21 is inserted in any one of the mounting holes 20, the fitting projection 36 is fitted in the fitting hole 51, and then the handle 7 is fixed with a fixing nut 56 via a washer 55. In this manner, the handle 7 is attached to the upper stem 35 as the direction of the handle 7 and of its opening/closing operation is set arbitrarily.

This case offers the following features: a feature that the direction of the exhaust outlet 12 can be reversed at 180 degrees by switching the direction of the two inline outflow/inflow ports 10 and 11, a feature that the direction of the handle 7 in its open position can be changed to a direction parallel with or crossing the outflow/inflow ports 10 and 11 via the fitting hole 51 and fitting projection 36, and a feature that the direction of operation of the handle 7 in opening/closing operations can be changed by inserting the locking pin 21 in any one of the mounting holes 20 of the body 2. Combining these three features provides various forms of valves. To put it another way, two kinds of pipelines connected to the exhaust outlet 12 for venting are created as a pipeline on the right of the inline outflow/inflow ports 10 and 11 and a pipeline on the left of the same when the handle is at its closed position, the handle 7 has two types of open positions, i.e., a parallel open position and a right angle open position, and the handle 7 has two operation directions, i.e., right-free operation direction and left-free operation direction. Combining these features thus provides 2×2×2=8 kinds of rapid exhaust valves. As a result, a desired configuration can be achieved according to the position of attachment of the valve main body 1 to the air piping 71 of the railway vehicle 70 and the direction of the exhaust outlet 12. For example, by changing the direction of the valve main body 1 upon its attachment, the operability of the handle 7 can be improved, or by changing the direction of the exhaust outlet 12, discharge of pressure air toward an operator can be avoided.

Following attachment of the valve main body 1, the handle 7 is rotated, with the gap G being formed between the valve element housing portion 16 and the spherical surface portion 28. This allows the valve element 3 to be rotated at every 90 degrees while preventing an accident caused by malfunction. Hence any one or all of a set of the outflow/inflow port 10 or 11 and the exhaust outlet 12 are connected communicatively to each other to allow channel switching via the through-holes 30, 31 and 32 and the seal 5. When the valve element 3 is at its close position, the seal 5 seals any one of the outflow/inflow ports 10 and 11 and the exhaust outlet 12.

FIG. 3 (a) depicts a case where the left and right outflow/inflow ports 10 and 11 are connected communicatively to each other to allow pressure air supply as the exhaust outlet 12 is sealed directly with the seal 5. FIG. 3 (b) depicts a case where the primary-side outflow/inflow port 10 is sealed with the seal 5 as the secondary-side outflow/inflow port 11 and the exhaust outlet 12 are connected communicatively to each other. In this case, pressure air flows from the outflow/inflow port 11 to the exhaust outlet 12 to be discharged. FIG. 3 (c) depicts a case where the primary-side outflow/inflow port 11 is sealed with the seal 5 as the secondary-side outflow/inflow port 10 and the exhaust outlet 12 are connected communicatively to each other. In this case, pressure air flows from the outflow/inflow port 10 to the exhaust outlet 12 to be discharged.

In a case other than these cases, two outflow/inflow ports 10 and 11 and the exhaust outlet 12 are all connected communicatively to each other. This case, however, is not a proper case of using the rapid exhaust valve as the exhaust valve for railway vehicles, and is therefore not described.

A different case may be considered applicable, where the body of the valve main body is provided with three or more outflow/inflow ports between which one exhaust outlet is formed and at least one of the outflow/inflow ports and the exhaust outlet are connected communicatively to each other.

A communication hole having the desired area of exhaust outlet S may be bored directly on the exhaust outlet of the body, instead of attaching the orifice serving as the mechanism that adjusts the area of exhaust outlet S.

According to the valve main body 1 of this embodiment of the present invention, the outflow/inflow ports 10 and 11 and the exhaust outlet 12 are formed on the valve element housing portion 16 having the spherical surface portion 15 such that the outflow/inflow ports 10 and 11 and the exhaust outlet 12 are almost identical in bore diameter with each other. The valve element 3 with the spherical surface portion 28 having the through-holes 30, 31, and 32 and the seal 5 is inserted rotatably into the valve element housing portion 16 through the opening 22 to give the body 2 the one-piece structure. The state of communication between the outflow/inflow ports 10 and 11 and exhaust outlet 12 and the through-holes 30, 31 and 32 through the full bore diameter is ensured. Any one of the outflow/inflow ports 10 and 11 and the exhaust outlet 12 is sealed up with the seal 5 to allow communication between the outflow/inflow ports 10 and 11 and the exhaust outlet 12 or between the outflow/inflow port 10 and the outflow/inflow port 11 through the through-holes 30, 31, and 32. By properly adjusting the area of exhaust outlet S, the venting time for venting from the pressure piping 71 for the vehicle in an emergency situation or during maintenance work can be determined to be the given time. The area of exhaust outlet S thus can be reduced from the full bore diameter to the given bore diameter Φd through the communication hole 60 of the orifice 8.

Hence, in the state of communication between the outflow/inflow port 10 and the outflow/inflow port 11 as shown in FIG. 3(a), a large amount of supply of pressure air is ensured. On the other hand, as shown in FIGS. 3(b) and 3 (c), when the exhaust outlet 12 and the outflow/inflow ports 11 and 12 are connected communicatively with each other for carrying out repair/maintenance of the railway vehicle 70 or dealing with an emergency situation, residual air on the secondary side can be discharged in a desired time as the flow rate of outflow of pressure air is adjusted by the orifice 8. As a result, the venting time can be reduced to a time within the given time. When an automatic door opening/closing gear 120, which will be described later, is stopped, therefore, an automatic door 121 can be manually opened and closed quickly.

In this configuration, the valve main body 1 is of the trunnion structure in which the upper stem 35 is fitted pivotally in the fitting hole 18 of the body 2 while the lower stem 37 is fitted pivotally in the fitting hole 45 of the lid 4. This prevents the valve element 3 from being moved toward the secondary side by air pressure. Because the valve element 3 is provided with the seal 5 that closes up the outflow/inflow ports 10 and 11 or the exhaust outlet 12, multiple seals, which is required by an ordinary ball valve, are not necessary and the channel can be switched using one seal 5. Because of this advantage, high machining precision for machining the spherical surface portion 15 of the body 2, the spherical surface portion 28 of the valve element 3, and the seal 5 is not necessary, which leads to a fewer number of components, overall simplification, and a reduction in size and weight. If the high machining precision of the spherical surface portion 15 of the valve element housing portion 16, more specifically, the high machining precision of opening part of the outflow/inflow ports 10 and 11 (valve seat surface of the body) is ensured, the valve can be assembled easily into a prescribed condition with secured sealing performance, by inserting the valve element 3 into the body 2 and closing the opening with the lid 4. In this assembling, the seal 5 is disposed in the given location to allow various patterns of channel switching. Providing only one seal 5 prevents formation of a sealed space, which occurs in the floating ball valve, thus never causing an abnormal pressure increase.

In close-valve mode, the seal 5 is pressed by the opening part of the outflow/inflow ports 10 and 11 or the exhaust outlet 12 to allow the sealing surface to elastically or plastically deform, thus exerting high sealing performance to certainly prevent entry of a foreign object or fluid leakage. For example, when the seal 5 is about to expand due to supply of high-temperature air, the pressure-applying structure of the spring 6 adds an extra sealing force to the seal, preventing leakage caused by jamming, creeping, stress release, etc. When the seal 5 is about to contract under a low temperature, the spring 6 offers a pressing force necessary for sealing against fluid leakage. Hence sufficient sealing performance is ensured in both cases.

The above features allow the valve to exert high sealing performance against high-pressure air while maintaining compactibility.

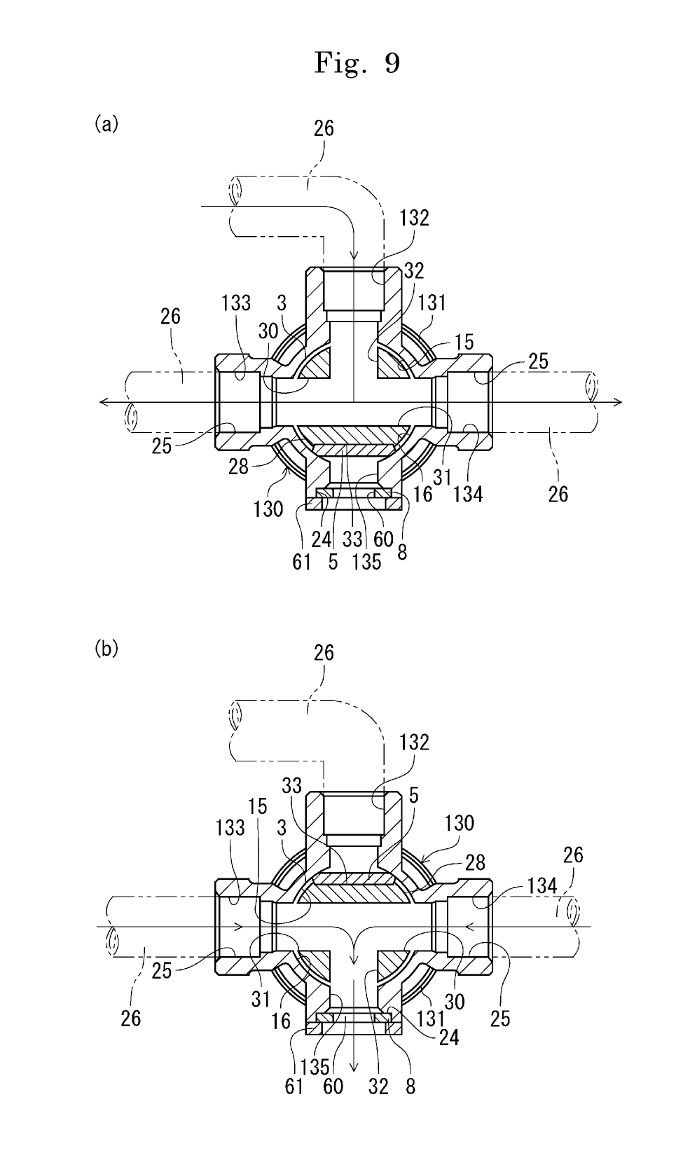

FIG. 9 depicts another example of the rapid exhaust valve for railway vehicles according to the present invention. In this example, the same constituent elements as described in the above embodiment will be denoted by the same reference numerals and omitted in further description.

A valve main body 130 in this example is configured such that a body 131 has three outflow/inflow ports 132, 133, and 134 formed in three directions at 90 degrees intervals, that one exhaust outlet 135 is formed between the outflow/inflow ports 132, 133, and 134, and that when the valve element 3 in its state of pressure air supply is rotated, at least one of the outflow/inflow ports 132, 133, and 134 can be connected communicatively with the exhaust outlet 135.

In this case, when the outflow/inflow port 132 is on the primary side while the outflow/inflow ports 133 and 134 are on the secondary side, for example, in the state of pressure air supply shown in FIG. 9(a), pressure air from the outflow/inflow port 132 branches into branches of air supplied to the outflow/inflow ports 133 and 134, respectively, as indicated by arrows in FIG. 9(a).

When the handle 7 is rotated at 180 degrees to shift the state of FIG. 9(a) to a state of the valve element shown in FIG. 9(b), pressure air is discharged at once from the outflow/inflow ports 133 and 134, which were on the secondary side in the state of FIG. 9(a), through the exhaust outlet 135 to the outside, as indicated by arrows in FIG. 9(b).

If a two-way valve is used for branch channels, such joints as branch T-joints and nipple joints for connecting them are needed, in addition to the two-way valve. Using the above valve main body 130, which is a three-way valve, makes these valve and joints unnecessary. Using the valve main body 130 for the air piping 71 laid in a tiny space in the railway vehicle 70, therefore, offers advantages in terms of piping work, cost, and weight reduction. In another case, four or more outflow/inflow ports in four or more directions and one exhaust outlet may be formed on the body of the valve main body (not depicted) and the valve element having proper through-holes may be formed in the body.

If the above nozzle 80 or elbow pipe 83 is connected to the exhaust outlet 135 of the valve main body 130 to allow the venting direction to be changed in four directions or arbitrary directions in 360 degrees shifting, the valve main body 130 can be set in a reasonable venting direction corresponding to its location of installation.

A piping system of a railway vehicle using the rapid exhaust valve for railway vehicles will then be described.

In the case of an ordinary railway vehicle, a door opening/closing time consists of an average opening time of 2 to 4 seconds and an average closing time of 3 to 5 seconds. These opening time and closing time are greatly influenced by the value of air pressure for moving a piston in a door driving cylinder incorporated in the automatic door opening/closing gear in an opening or closing direction, the capacity of the door driving cylinder, and the size of the area of the exhaust outlet for discharging residual pressure air from a cylinder chamber in an closing or opening direction.

The time required for manually opening each door is the average opening time mentioned above. When all doors are manually opened at once, however, because of the influence of the volume of residual pressure air and the value of residual air pressure, a time longer than the average opening time is required as a time that is taken to make manual operation possible.

When the doors of the same railway vehicle are opened, for example, doors in different areas may be opened, which include a case of emergency door opening from inside the railway vehicle (opening each door in emergency, opening left-side or right-side doors at once, opening both left-side and right-side doors at once) and a case of emergency door opening from outside the railway vehicle (opening left-side or right-side doors at once, opening both left-side and right-side doors at once). During these door opening operations, if the capacity of air piping including the door cylinders varies depending on the above door opening patterns in a process of closing each valve to stop air supply and discharging pressure air inside the cylinder, the venting time for discharging pressure air that is taken to make manual door opening possible varies, posing a problem that a larger piping capacity results in a longer time for making manual door opening possible, thus leading to a longer time for evacuation or maintenance work.

When a conventional cock or valve with an exhaust outlet is employed, the exhaust outlet is small and is not size-adjustable. This leads to a case where the venting time required for making door opening possible becomes different for each venting pattern for each different exhaust capacity. Specifically, for example, at a location near the cylinder, door opening becomes possible in a short venting time, such as several seconds. When the left-side doors or the right-side doors are opened at once, however, the piping capacity becomes large, increasing the venting time to, for example, scores of seconds, in which case a longer time is needed to make door opening possible. In this manner, in the case of the conventional cock or valve with the exhaust outlet, the venting time varies depending on the piping capacity for each door opening/closing pattern, leading to a change in the time taken to make the door operation possible. In the case of evacuation in an emergency situation or maintenance work, therefore, occupants have to wait for a long time.

In the case of a two-way or three-way cock valve with an exhaust outlet and a two-way or three-way ball cock valve with an exhaust outlet each having a conventional structure, solving these problems is difficult. A valve having a flow passage area equivalent to an area determined by the inner diameter of the air piping has a large overall size. As a result, installing the valve in piping in a small space in the vehicle becomes difficult, and the large weight of the valve makes it difficult to meet a requirement for reducing the weight of the vehicle. Besides, opening/closing the valve requires a large torque, which makes handle operation difficult for a physically weak occupant, such as elderly person. The ball cock valve is structured such that separate parts of the body are fastened with screws. This increase various risks, such as damage to the valve that is caused when it is screwed into a pipe and a pressure air leak from a screw joint loosened by the vehicle's vibrations.

In comparison, according to the piping system of the railway vehicle using the rapid exhaust valve for railway vehicles according to the present invention (hereinafter, referred to as “system main body 140”), as shown in FIGS. 10 to 14, a plurality of the above valve main bodies 1 are arranged in the middle of lines of a main pipe 141 and branch pipes 142 of the air piping 71 that drives the automatic door opening/closing gear 120 of the railway vehicle 70 indicated by a two-dot chain line or in a pipeline branch section 143, and a variation in the venting time of each valve main body 1 is prevented to keep the venting time constant.

In this configuration, depending on the location of arrangement of the valve main bodies 1 in the railway vehicle 70, the area of exhaust outlet S is determined properly by the orifice 8 to adjust the venting time as the air piping 71 is reduced in size and weight as a whole. As a result, even when the piping capacity changes depending on door opening/closing patterns, venting can be performed within a given short time. In such a case, the valve main body 1 can be operated by a small force and can be connected to the air piping 71 via the body 2 of the integral structure. Pressure air leakage to the outside is, therefore, prevented.

By disposing the valve main body 1 in the middle of the pressure piping 71 for door opening inside or outside the railway vehicle 70, the automatic door 121 can be opened manually from inside or outside the railway vehicle 70. A desired area of the pressure piping 71, therefore, can be quickly exhausted of air in an emergency situation or during maintenance work.

The system main body 140 of this embodiment includes a compressing device 150 composed of a compressor and an air accumulating unit 151 composed of a chamber and an accumulator, the compressing device 150 and air accumulating unit 151 being located on the primary side. The air piping 71 serving as a pressure air supply/discharge path for driving the automatic door opening/closing gear 120 is connected to the compressing device 150 and to the air accumulating unit 151. The air piping 71 is provided with the automatic door opening/closing gear 120 having a built-in cylinder driven by an opening/closing electromagnetic valve, which is not depicted, and with the valve main body 1. In the system main body 140, pressure air generated by the compressing device 150 is supplied to the air piping 71 via the air accumulating unit 151.

In FIG. 10, the air piping 71 indicated by a continuous line is branched into a first branch path 153 on the left and a second branch path 154 on the right, both branch paths being the branch pipes 142, by a T-joint, i.e., pipeline branch section 143 provided in the middle of the air piping 71. These first and second branch paths 153 and 154 are each provided with multiple automatic door opening/closing gears 120. In the middle of lines of the main pipe 141 and branch pipes 142 of the air piping 71, the above two-way valve main bodies 1 are arranged. The T-joint 143 serving as the pipeline branch section may be replaced with the valve main body 130. Among these components, the valve main bodies 1 located on the primary side relative to the T-joint 143 each communicatively connect the outflow/inflow ports 10 and 11 leading to the pipeline and the exhaust outlet 12 with each other through the through-holes 30, 31, and 32 to discharge pressure air from all automatic door opening/closing gears 120 or communicatively connect the outflow/inflow ports 10 and 11 with each other through the through-holes 30, 31, and 32 to supply pressure air to all automatic door opening/closing gears 120.

In the first and second branch paths 153 and 154, the valve main bodies 1 arranged between the T-joint (pipeline branch section) 143 and the automatic door opening/closing gears 120 communicatively connect the outflow/inflow ports 10 and 11 and the exhaust outlets 12 on the pipeline closer to the T-joint 143 with each other to discharge pressure air from all automatic door opening/closing gears 120 on the left and right sides or communicatively connect the outflow/inflow ports 10 and 11 with each other to supply pressure air to all automatic door opening/closing gears 120 on the left and right sides.

The valve main body 1 disposed on the primary side of each automatic door opening/closing gear 120 communicatively connects the outflow/inflow ports 10 and 11 leading to the automatic door opening/closing gear 120 with the exhaust outlet 12 to discharge pressure air from the automatic door opening/closing gears 120 or communicatively connects the outflow/inflow ports 10 and 11 with each other to supply pressure air to the automatic door opening/closing gear 120.

According to this embodiment, the valve main bodies 1 are arranged inside and outside the railway vehicle 70 and when opened and closed, pressure air is discharged from and supplied to the automatic door opening/closing gear 120. More specifically, valve main bodies 1 on the primary side relative to the first and second branch paths 153 and 154 are usually each concealed with a glass board set openable/closable by a hinge in a proper location inside the railway vehicle 70, which is not depicted, and in an emergency situation or during maintenance work, the glass board is opened to allow the valve main body 1 to be operated manually with the handle 7 from inside the railway vehicle 70. Valve main bodies 1 set exposed on the left/right side and front/rear sides of the railway vehicle 70 can be manually operated in every direction outside the railway vehicle 70. Each valve main body 1 disposed above each automatic door 121 is concealed under a steel plate set openable/closable by a hinge, and by opening the steel plate, can be operated manually from inside the railway vehicle 70.

In FIG. 10, in ordinary operation mode, the outflow/inflow ports 10 and 11 of the every valve main body 1 are connected communicatively with each other to allow pressure air to be supplied to the automatic door opening/closing gear 120. In this case, opened or closed electromagnetic valve drives the cylinder, which causes the automatic door opening/closing gear 120 to open or close the door, thus allowing people gets in or out of the railway vehicle 70.

Various cases where air is discharged from the air piping 71 of the system main body 140 by manual operation of the valve main body 1 will then be described.

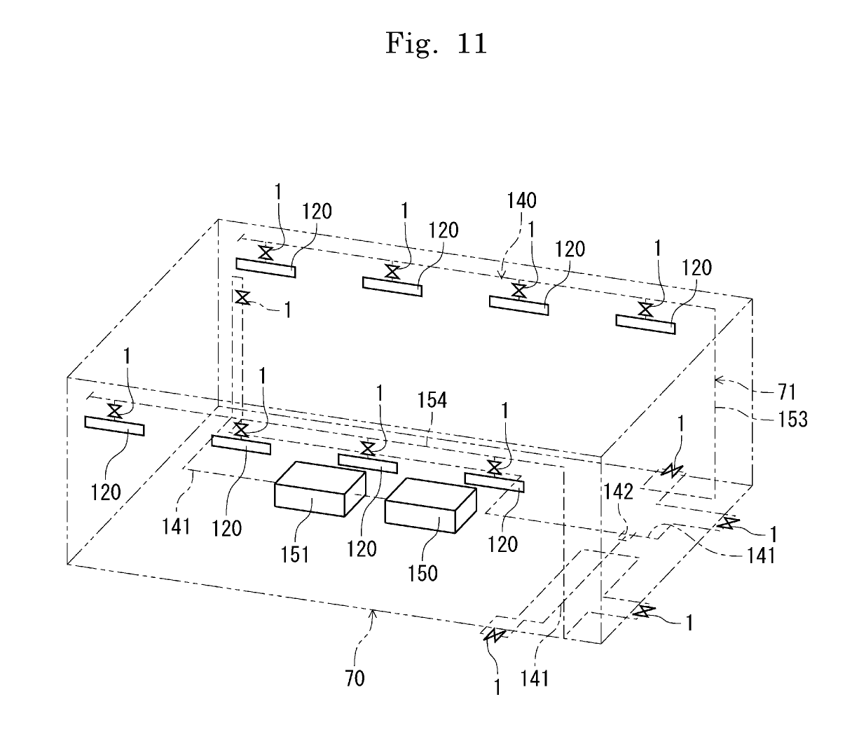

FIG. 11 depicts a venting state where in an emergency situation, only the specific automatic door opening/closing gear 120 is rendered manually openable. In the following drawings, single-dot chain lines represent a state of pressure air supply to the air piping 71 and broken lines represent a state of pressure air discharge from the air piping 71.

When one valve main body 1 among valve main bodies 1 connected to the automatic door opening/closing gears 120 is manually operated to put the valve main body 1 in venting state, only the automatic door opening/closing gear 120 connected to this valve main body 1 is rendered manually openable, and therefore can be opened. To the other automatic door opening/closing gears 120, pressure air is supplied to keep doors closed.

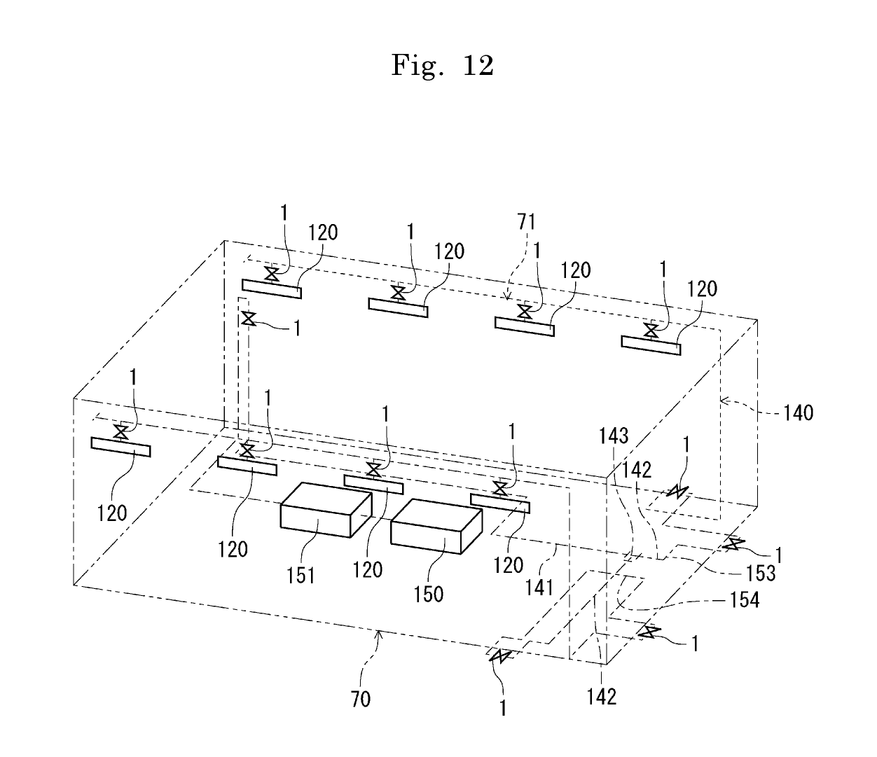

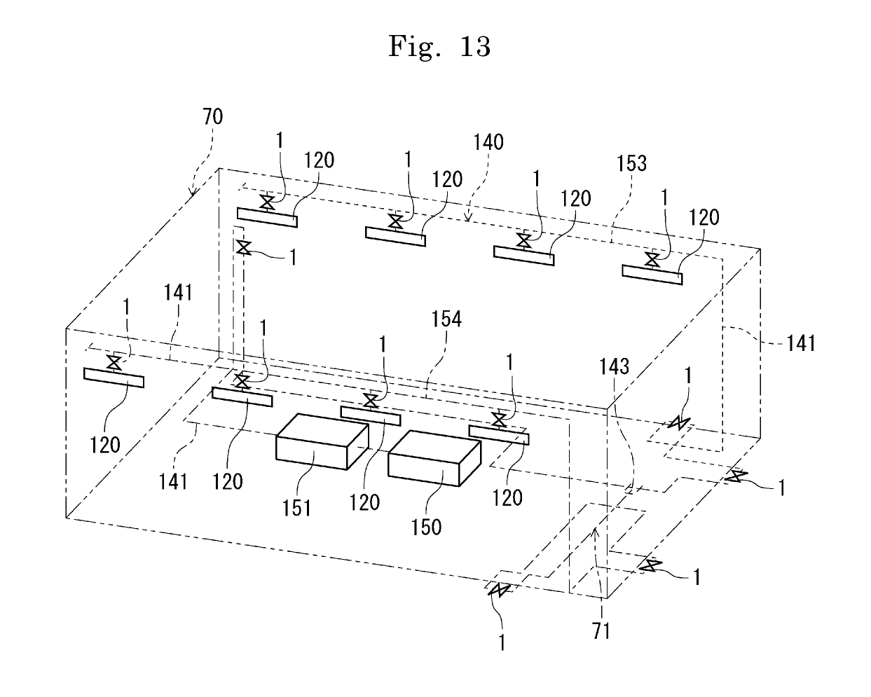

FIG. 12 depicts a venting state where in an emergency situation, either the left-side or right-side doors are rendered manually openable at once. In this case, valve main bodies 1 on the sides and outside of the railway vehicle 70 are manually operated to put the secondary-side air piping in venting state, which allows any given door among the left-side or right-side doors to be manually opened. In FIG. 13, as in the case of FIG. 12, depicts a venting state where in an emergency situation, either the left-side or right-side doors are rendered manually openable at once. In this case, valve main bodies 1 on the front and rear sides of the railway vehicle 70 are manually operated to put the secondary-side air piping in venting state, which allows any given door among the left-side or right-side doors to be manually opened.

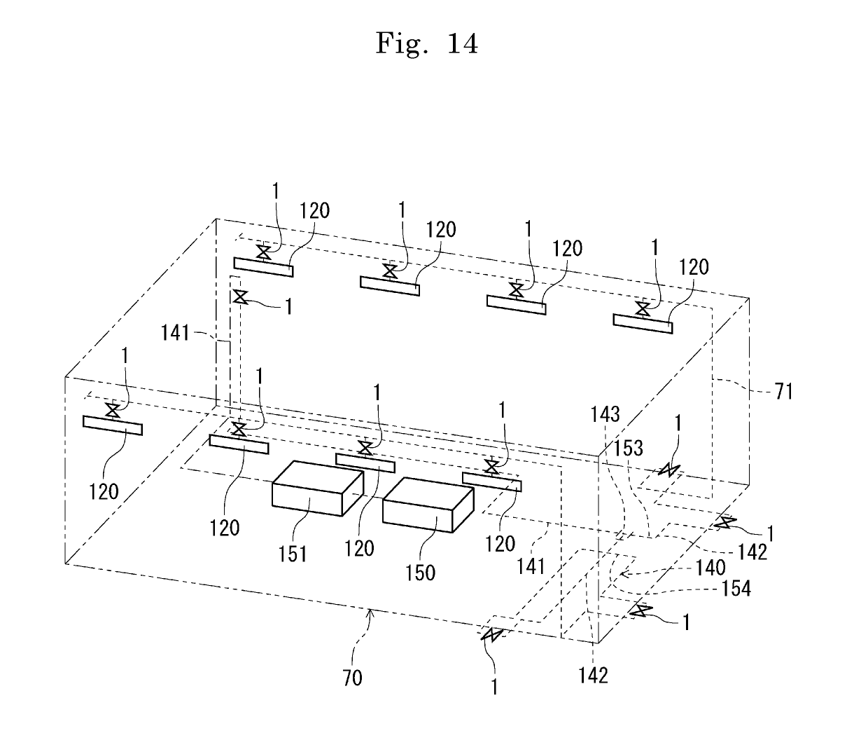

FIG. 14 depicts a venting state where in an emergency situation, the entire door opening/closing gears 120 of the railway vehicle 70 are rendered capable of manual opening operation. In this case, valve main bodies 1 inside the railway vehicle 70 are manually operated to put the secondary-side air piping 71 in venting state, which allows any given door among the entire doors of the railway vehicle 70 to be manually opened.

In these cases, orifices 8 different in the area of exhaust outlet S from each other are attached to the exhaust outlet 12 of the valve main bodies 1 of the railway vehicle 70, respectively, so that in each venting state, the venting time can be set constant and can be reduced. As a result, without being affected by the capacity (length) of the air piping 71 for door opening/closing, which vary depending on the type of the railway vehicle 70, or the location of arrangement of the valve main bodies 1, the bore diameter Φd of the orifice 8 is determined from outside as the valve main body 1 is installed in the piping. Hence the time required for making the door manually openable is adjusted, and pressure air is discharge from the air piping 71 within, for example, 5 seconds according to this embodiment, to allow the door opening operation.

In addition, the valve main body 1 can be disposed in the main pipe 141, in the middle of lines of the branch pipes 142, or in the pipeline branch section 143 of the air piping 71 for the door opening/closing gears 120 of the railway vehicle 70 and therefore can be disposed in a desired location in the air piping 71 that varies depending on the type of each railway vehicle 70, in which the valve main body 1 changes the channel to allow rapid venting from a desired location, thereby allow venting from a given area in the railway vehicle 70 within a given time. When piping is complicated, the valve main body 1 is installed in a given location in the piping to reduce the venting time for discharging pressure air to the given time.

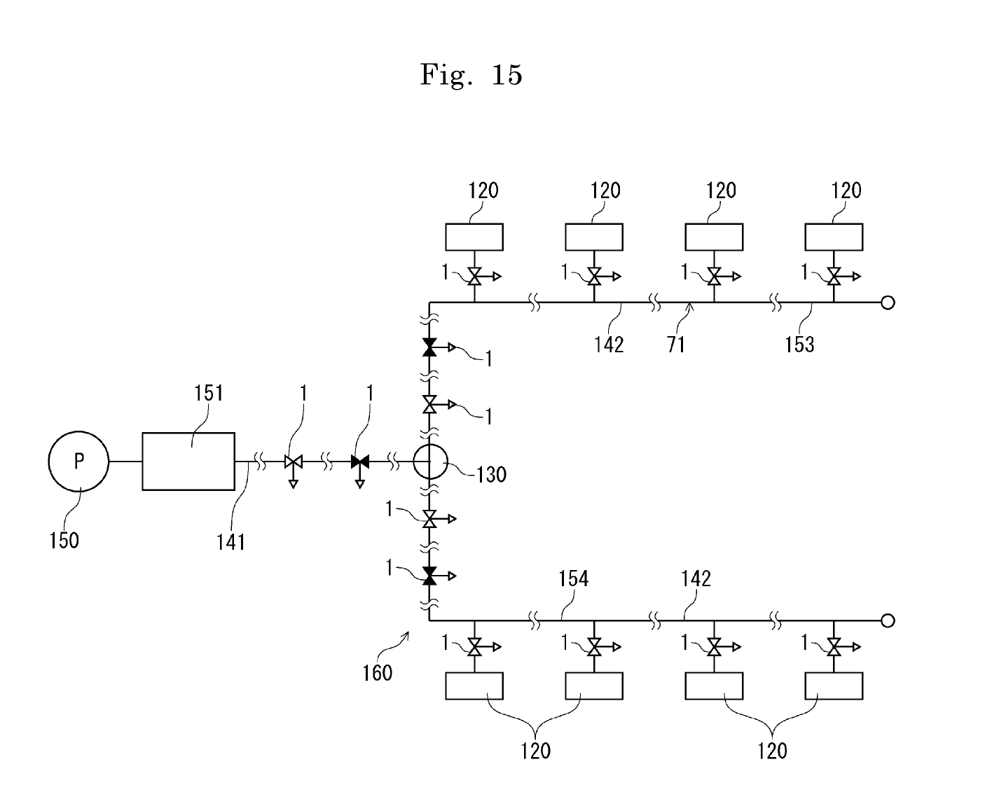

FIG. 15 depicts another example of the piping system of the railway vehicle. A system main body 160 of this example includes the compressing device 150 and the air accumulating unit 151 that are located on the primary side in the same manner as in the above system main body 140. The air piping 71 for driving the automatic door opening/closing gear 120 is connected to the compressing device 150 and to the air accumulating unit 151. The air piping 71 is provided with the two-way valve main bodies 1 of FIG. 3 installed inside and outside the vehicle. The system main body 160 also includes the three-way valve main body 130 of FIG. 9 disposed in the middle of the air piping 71. The valve main body 130 is disposed in the pipeline branch section 143 between the first branch path 153 and the second branch path 154 such that the outflow/inflow port 132 is directed to the primary side while the outflow/inflow ports 133 and 134 are directed to the secondary side.

In ordinary operation mode, the outflow/inflow port 132 is connected communicatively with the outflow/inflow ports 133 and 134 to allow pressure air to be supplied to all automatic door opening/closing gears 120, as shown in FIG. 9(a).

When the outflow/inflow ports 133 and 134 are connected communicatively with the exhaust outlet 135, as shown in FIG. 9(b), the doors on both sides of the railway vehicle 70 can be manually operated at once.

When the three-way valve main body 130 is provided in place of the T-joint serving as the pipeline branch section 143, valves on the primary side relative to the valve main body 130 become unnecessary, which allows space-saving.

In the case of the system main body 160 of FIG. 15, for example, the orifices 8 are attached to the valve main bodies 1 such that the orifice bore diameter of each valve main body 1 disposed on the primary side relative to the pipeline branch section 143 is determined to be 10 mm, the orifice bore diameter of each valve main body 1 disposed on each pipeline leading from the pipeline branch section 143 to the left/right doors is determined to be 7 mm, and the orifice bore diameter of each valve main body 1 disposed in front of the automatic door opening/closing gear 120 is determined to be 5 mm. By this arrangement, even when different air discharge volumes result because of different pipe lengths resulting from different types of railway vehicles 70 and different manufacturers, the venting time of each valve main body 1 in a venting area in which a given door opening pattern is adopted can be determined to be a given short time.

A working example of the rapid exhaust valve for railway vehicles according to the first embodiment will then be described. The venting time of the system main body 160 in one unit of the railway vehicle 70 of FIG. 15 is determined through simulations. Simulation conditions are set such that the pipe diameter of the air piping 71 is determined to be ⅜ B, i.e., ⅜ inch, the bore diameter of the exhaust outlet 135 to be 10 mm, the bore diameter of the orifice 8 to be 10 mm, 7 mm, or 5 mm, and the pressure of pressure air to be 0.49 MPa, under which conditions venting times needed for the automatic door opening/closing gear 120 to make a manual opening operation possible are determined for respective venting patterns through simulations, using a calculation formula based on JISB8373. The venting patterns of the air piping 71 and simulation results corresponding to the venting patterns are shown in a table 1. For a comparison purpose, the results of simulations carried out for respective venting patterns, using a three-way cock, i.e., ball valve for railway vehicles of an ordinary structure with a bore diameter on the venting side determined to be 5 mm, under the same conditions for the pipe diameter of the air piping and the pressure of pressure air as the above condition are shown in table 2.

TABLE 1

| | | | | Operating rapid | |
|---|---|---|---|---|---|
| | Operating rapid exhaust | | | exhaust vales outside | |
| | vales inside the vehicle | | | the vehicle | |
| | | Venting | | Venting | |
| | | from all | | from all | |
| | | doors on | | doors on | |
| | | either | Venting | either | |
| | | the left | from all | the left | Venting |
| | | side or | doors on | side or | from all |
| | Venting | right | both | right | doors on |
| | from | side of | sides of | side of | both sides |
| Venting | each | the | the | the | of the |
| pattern | door | vehicle | vehicle | vehicle | vehicle |
| Orifice | Φ5 | Φ5 | Φ7 | Φ7 | Φ10 |
| exhaust | | | | | |
| bore | | | | | |
| diameter | | | | | |
| (mm) | | | | | |
| Set air | 2.5 | 10 | 20 | 20 | 40 |
| piping | | | | | |
| capacity | | | | | |
| (dm³) | | | | | |
| Venting | About 2 | About 5 | About 5 | About 5 | About 5 |
| time | | | | | |
| (sec.) | | | | | |

TABLE 2

| | | | | Operating rapid | |
|---|---|---|---|---|---|
| | Operating rapid exhaust vales | | | exhaust vales | |
| | inside the vehicle | | | outside the vehicle | |
| | | Venting | | Venting | |
| | | from all | | from all | |
| | | doors on | | doors on | |
| | | either | Venting | either | Venting |
| | | the left | from all | the left | from all |
| | | side or | doors on | side or | doors on |
| | | right | both | right | both |
| | Venting | side of | sides of | side of | sides of |
| Venting | from each | the | the | the | the |
| pattern | door | vehicle | vehicle | vehicle | vehicle |
| Orifice | Φ5 | Φ5 | Φ5 | Φ5 | Φ5 |
| exhaust | | | | | |
| bore | | | | | |
| diameter | | | | | |
| (mm) | | | | | |
| Set air | 2.5 | 10 | 20 | 20 | 40 |
| piping | | | | | |
| capacity | | | | | |
| (dm³) | | | | | |
| Venting | About 2 | About 5 | About 10 | About 10 | About 20 |
| time | | | | | |
| (sec.) | | | | | |

Comparing the table 1 with the table 2 reveals that using the piping system equipped with the rapid exhaust valve of the present invention can reduce the venting time to a venting time equal to or shorter than 5 seconds. When the conventional three-way cock for railway vehicles of the ordinary structure is used, on the other hand, the venting time has increased up to about 20 seconds at maximum. The simulation results also indicate that a variation in the venting time results depending on venting patterns. The above facts confirm that using the piping system equipped with the rapid exhaust valve of the present invention allows the venting time to be determined to be a short time within a given time.

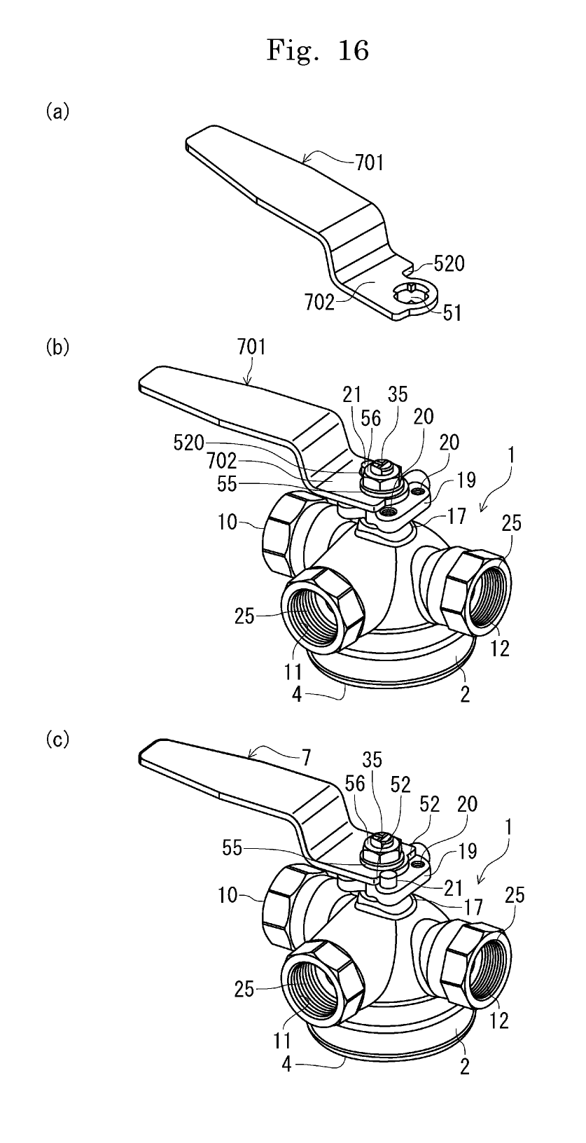

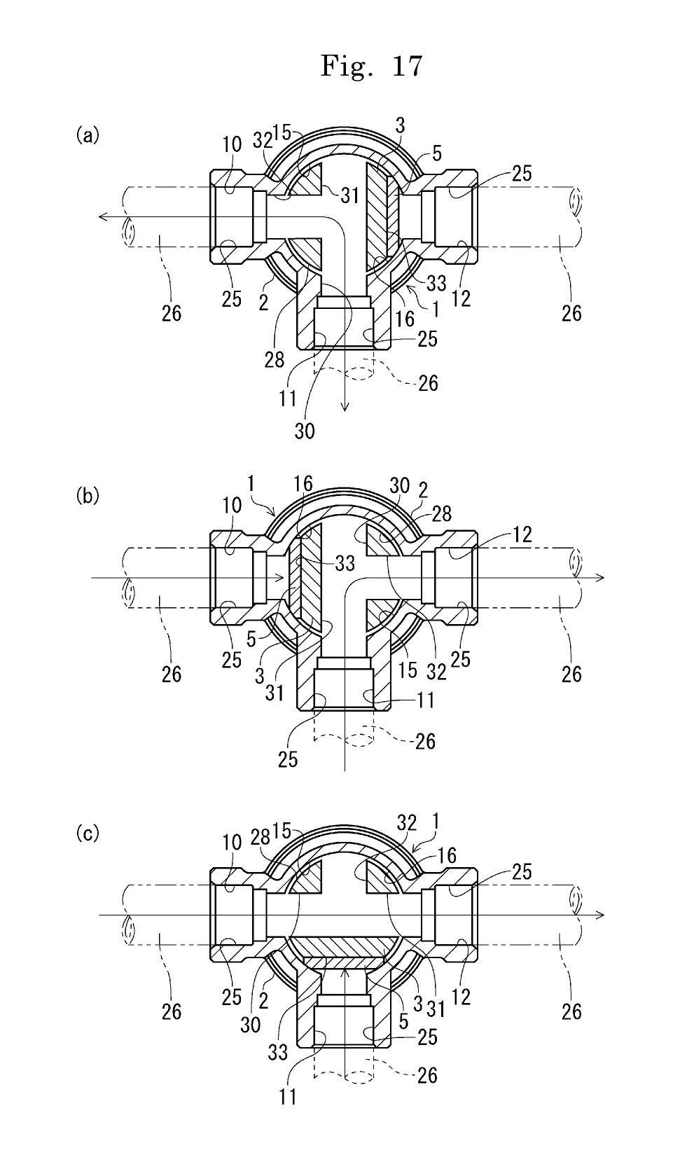

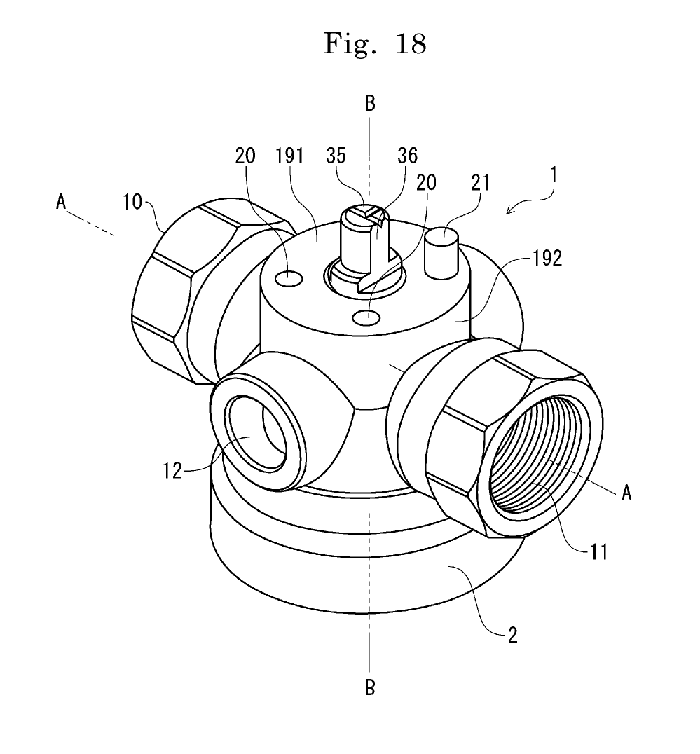

A second embodiment of the raid exhaust valve for railway vehicles according to the present invention will then be described. FIG. 16(a) is a perspective view of a handle 701, FIGS. 16(b) and 16(c) are perspective views of the rapid exhaust valve for railway vehicles according to the second embodiment of the present invention, and FIG. 17 exhibits sectional views showing a state of rotation of the valve element of the rapid exhaust valve for railway vehicles of FIGS. 16(b) and 16(c). The same constituent elements as described in the first embodiment will be denoted by the same reference numerals and will be omitted in further description.

FIG. 16(a) is a perspective view of the handle 701 attached to the valve main body 1 as a handle different in form from the handle 7, and FIG. 16 (b) is a perspective view showing the handle 701 attached to the valve main body 1 of the second embodiment. As shown in FIG. 16 (a), similar to the handle 7, the handle 701 has the almost cross-shaped fitting hole 51 formed on a connecting portion 702, and via the fitting hole 51, the handle 701 is fitted on the upper stem 35 such that the handle 701 is set in arbitrary direction at 90 degrees intervals. The fitting hole 51 may have a shape other than the almost cross shape on the condition that the handle 701 can be fitted on the upper stem 35 in arbitrary direction at 90 degrees intervals. The connecting portion 702 is fixed to the upper stem 35 with the fixing nut 56, via the washer 55.

The stopper portion 520 of the handle 701 is formed into a recessed cutout. As shown in 16 (b), when the handle 701 is attached to the valve main body 1, the stopper portion 520 comes in contact with the locking pin 21 inserted in any one of four mounting holes 20 and is locked by the locking pin 21. The stopper portion 520 thus sets the direction of the handle 701 and its operation direction, allowing the handle 701 to be rotated at 180 degrees in an arbitrary operation direction to change the channel.

FIG. 16(b) depicts a three-way valve having the exhaust outlet 12 and the outflow/inflow ports 10 and 11 crossing each other at right angles. When the outflow/inflow port 10 is connected to the primary side and the outflow/inflow port 11 is connected to the secondary side, the handle 701 is rotated at 180 degrees as opening/closing operations to connect the outflow/inflow ports 10 and 11 communicatively with each other, thereby supply pressure air for operation or close the outflow/inflow port 10 while connecting the outflow/inflow port 11 communicatively with the exhaust outlet 12, thereby discharge pressure air.

In FIG. 16(c), the outflow/inflow port 11 is connected to the primary side while the outflow/inflow port 10 is connected to the secondary side, in which case the handle 7 is rotated at 90 degrees as opening/closing operations to connect the outflow/inflow ports 10 and 11 communicatively with each other, thereby supply pressure air for operation or close the outflow/inflow port 11 while connecting the outflow/inflow port 10 communicatively with the exhaust outlet 12, thereby discharge pressure air.

At this time, the handle 7 is fitted on the upper stem 35 via the fitting hole 51 such that the handle 7 can be set in arbitrary direction at 90 degrees intervals, and the locking pin 21, on which the stopper portion 52 can be locked, is inserted in any one of the mounting holes 20 formed at 90 degrees intervals on the body 2 to allow the handle 7 to be fitted in arbitrary operation directions. This eliminates needs of providing a body having the exhaust outlet different in location from the outflow/inflow ports, changing the location of the stopper portion, and changing the location of the projection of the body on which projection the stopper portion is locked. Hence the valve using one type of body 2 and handle 7 can be installed according to the location and direction of the valve in the railway vehicle and therefore can be placed in a narrow space on the left and right side of the railway vehicle as the operability of the valve is ensured. When the handle 7 is rotated, the stopper portion 52 is locked by the locking pin 21 at 90 degrees intervals, which allows the handle 7 to be shifted certainly to a point of a given angle as its malfunction is prevented. Even if the valve main body 1 is disposed in a narrow space, dark place, etc., the valve element can be shifted easily to its open/close states by rotating the handle to its regulation position.

FIG. 17 (a) depicts a case where the outflow/inflow ports 10 and 11 are connected communicatively to each other to allow pressure air supply. FIG. 17 (b) depicts a case where the handle 7 or 701 in its position of FIG. 17(a) is rotated at 180 degrees as opening/closing operations to close the outflow/inflow port 10 while connecting the outflow/inflow port 11 communicatively with the exhaust outlet 12. FIG. 17(c) depicts a case where the handle 7 in its position of FIG. 17 (a) is rotated at 90 degrees as opening/closing operations to close the outflow/inflow port 11 while connecting the left-side outflow/inflow port 10 communicatively with the exhaust outlet 12. In a case other than these cases, two outflow/inflow ports 10 and 11 and the exhaust outlet 12 are all connected communicatively to each other. This case, however, is not a case where three outflow/inflow ports used for exerting the function of a D cock for railway vehicles are switched, and therefore will not be described.

In each of the above channel switching states, as the body 2 is structured as the one-piece structure, the outflow/inflow ports 10 and 11 and exhaust outlet 12 are connected communicatively with the through-holes 30, 31, and 32 through the full bore diameter to ensure the maximum channel area, thereby ensure a large flow rate. In the state of communication between the outflow/inflow port 10 and the outflow/inflow port 11 shown in FIG. 17(a), the volume of pressure air supply during the operation becomes large. In the states of communication between the outflow/inflow port 11 and the exhaust outlet 12 and between the outflow/inflow port 10 and the exhaust outlet 12 shown in FIGS. 17(b) and 17(c), respectively, residual air on the secondary side can be discharged in a short time through the through-holes 30, 31, and 32 during repair/maintenance of the vehicle or in an emergency situation.

An ordinary ball valve is structured such that seals are arranged on the outflow/inflow port sides, respectively, that a ball valve element is disposed in a position at which a necessary sealing surface pressure is applied to the seals, and that the ball valve element is rotated to seal up a fluid. According to the ball valve, to close each outflow/inflow port, the seal must be set at a position at which its diameter made larger toward its outer peripheral edge than the channel path diameter of the outflow/inflow port, that is, the seal must be brought in pressure contact with (i.e., caused to interfere with) a sealing surface on the outer peripheral edge of the channel diameter on the spherical surface of the ball valve element.

In addition, to close two or more outflow/inflow ports, two or more seals and members for holding them are required, respectively. For this reason, as the number of outflow/inflow ports increases, the valve structure becomes more complicated, which leads to an increase in the size and weight of the valve and to a demand for the high precision of components.

As described above, because the seal must be disposed at the position at which the seal interferes with the ball valve element and be brought in pressure contact with the ball valve, the internal structure of the ball valve becomes complicated. For example, according to a floating ball valve of the one-piece structure, an insert separated from the body is provided, and this insert is screwed in through the piping connection of the body to protect the seal, which is fastened together with the ball valve element along the direction of the channel. According to a floating ball valve of a two-to-four piece structure, a cap separated from the body is provided, and this cap is screwed in from the channel side of the body to hold the seal, which is fastened together with the ball valve element along the direction of the channel. In a trunnion ball valve, each seal is fastened from the piping connection side of the body such that the seal is brought in contact with the ball valve element along the direction of the channel.

Because the number of components increases in the above manner, according to the conventional ball valve, assembling manhour also increases. Replacing a worn or deteriorated seal, consumable, etc., therefore, takes such trouble as removing the valve from piping, disassembling the valve, and replacing the seal, consumable, etc. with new one.

In addition, the sealing performance and sliding performance are greatly affected by the positions of the ball valve element and seal. Further, high machining precision is required in order to set the seal in place and prevent a fluid leak from a joint between the insert or cap and the body.

Different from the above ordinary ball valve, the exhaust valve for railway vehicles according to the above embodiment of the present invention has the trunnion structure in which the upper stem 35 is fitted pivotally in the fitting hole 18 of the body 2 while the lower stem 37 is fitted pivotally in the fitting hole 45 of the lid 4. This structure prevents the valve element 3 from being moved toward the secondary side by pressure. Because the valve element 3 is provided with the seal 5 that closes the outflow/inflow ports 10 and 11 and exhaust outlet 12, the channel can be switched using one seal 5 without requiring multiple seals, which are required by an ordinary ball valve. This eliminates the need of the high machining precision of the spherical surface portion 15 of the body 2, spherical surface portion 28 of the valve element 3, and seal 5, reduces the number of components to simplify the overall structure, thus reducing the size and weight of the valve. If the high machining precision of the spherical surface portion 15 of the valve element housing portion 16, more specifically, the high machining precision of opening part of the outflow/inflow ports 10 and 11 (valve seat surface of the body) is ensured, the valve can be assembled easily into a prescribed condition with secured sealing performance, by inserting the valve element 3 into the body 2 and closing the opening with the lid 4. In this assembling, the seal 5 is disposed in the given location to allow various patterns of channel switching while preventing an abnormal rise in pressure.

Because a pipe 26 can be connected to a screw portion 25 of the body 2 compactified in the above manner, when the pipe 26 shown in FIG. 17 is provided as a bent pipe, such as elbow pipe, channel connection to complicated piping becomes easy. During venting work, therefore, pressure air from the exhaust outlet 12 hitting a worker is prevented, and entry of an extraneous foreign object in the exhaust outlet 12 is also prevented.

Giving the valve element 3 the structure pivotally supported between the body 2 and the lid 4 to improve the torque performance reduces a load on the handle 7 upon operating it, thus making the opening/closing operations of the valve 3 smooth.

In this configuration, the upper stem 35 and lower stem 37 are made almost identical in diameter with each other to apply an equal pressure to the vale element 3. This keeps the operation torque low to allow the valve element 3 to be opened and closed with stable operability.

Because of these features, even if the valve is disposed in a narrow space in the railway vehicle, it can be operated easily with one hand without applying a large force to the valve.

The valve can be assembled easily by inserting the valve element 3 having the seal 5 attached thereto in advance into the body 2 of the one-piece structure through the opening 22 of the body 2 and screwing in the lid 4 while attaching the spring 6. The one-piece structure prevents leakage from the body 2 after it is connected to piping. Because disconnecting the body 2 from the piping is unnecessary upon replacing the seal 5, consumable, etc., manhour for assembling work or consumable replacement work can be reduced to the minimum. Because of the bottom entry structure in which the valve element 3 is pressed into the body 2 by the spring 6, a risk of the valve element 3 coming out of the body 2 does not arise, which ensures safety.

These features facilitate connection of the valve to the piping of the railway vehicle and maintenance work, thus allowing safe implementation of such work with no leakage problem.

When the lid 4 is screwed in the opening 22 by screw-engaging the male screw 43 with the female screw 23 during assembling work, the gap G is formed between the spherical surface portion 15 and the spherical surface portion 28 so that the spherical surface portion 28 of the valve element 3 and the inner spherical surface portion 15 of the body can rotate without rubbing against each other and that a fluid pressure is applied to the seal 5 only when it closes the outflow/inflow port or exhaust outlet. This reduces the wearout of the seal 5 to the minimum without using such a lubricant as grease and prevents the deformation or movement of the seal 5 by the fluid pressure, thus maintaining the high sealing performance and durability of the seal 5. With its wearout suppressed in this manner, the seal 5 offers a superior economic advantage, allowing a cost reduction when a number of seals 5 are provided in one pipeline in the railway vehicle.

The opening 22 is closed with the lid 4 that can be tightened further, and the resilient force of the spring 6 attached to the lid 4 causes the seal 5 to seal up any one of the outflow/inflow ports 10 and 11 and the exhaust outlet 12. In this structure, the spring 6 expands to a proper extent in a move following the wearout of the seal 5 to ensure the sealing performance. When maintaining the sealing performance becomes difficult due to the wearout of the seal 5 caused by its time-dependent change or repeated opening/closing of the valve element 3, the lid 4 is tightened further to increase the pressing force to the seal 5, thereby recovers the sealing performance. The seal 5, therefore, needs not be replaced frequently.

The seal 5 is hardly subjected to a bias fluid pressure, which prevents the deformation of the seal 5 to improve its durability.

When handle operations for venting from the exhaust outlet 12 becomes different as a result of switching of the pressure air supply ports of two outflow/inflow ports 10 and 11, no problem arises because of the configuration in which the handle 7 or 701 is fitted on the upper stem 35 via the fitting hole 51 such that the handle 7 or 701 can be set in arbitrary directions at 90 degrees intervals and the locking pin 21, on which the stopper portion 52 or 520 can be locked, is inserted in any one or two of the mounting holes 20 formed at 90 degrees intervals on the body 2 to allow the handle 7 or 701 to be fitted in arbitrary directions of opening/closing operations. Hence the valve using one type of body 2 and handle 7 or 701 can be installed according to the location and direction of the valve in the railway vehicle and therefore can be placed in a narrow space on the left and right side of the railway vehicle as the operability of the valve is ensured.

In this case, when the handle 7 or 701 is rotated, the stopper portion 52 or 520 is locked on the locking pin 21 at 90 degree intervals to allow the handle 7 or 701 to be shifted to a point of a given angle as its malfunction is prevented. Even if the valve main body 1 is disposed in a narrow space, dark place, etc., the valve element can be shifted easily to its prescribed open/close states by rotating the handle to its regulation position.

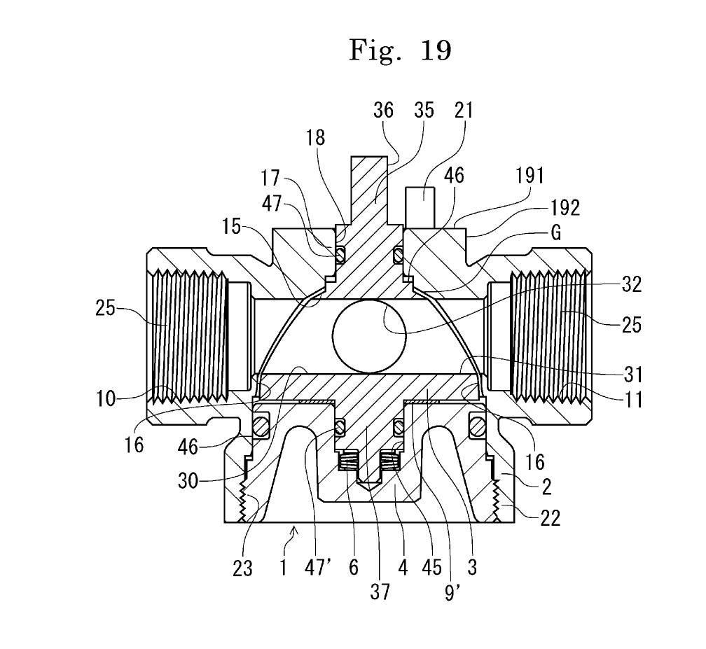

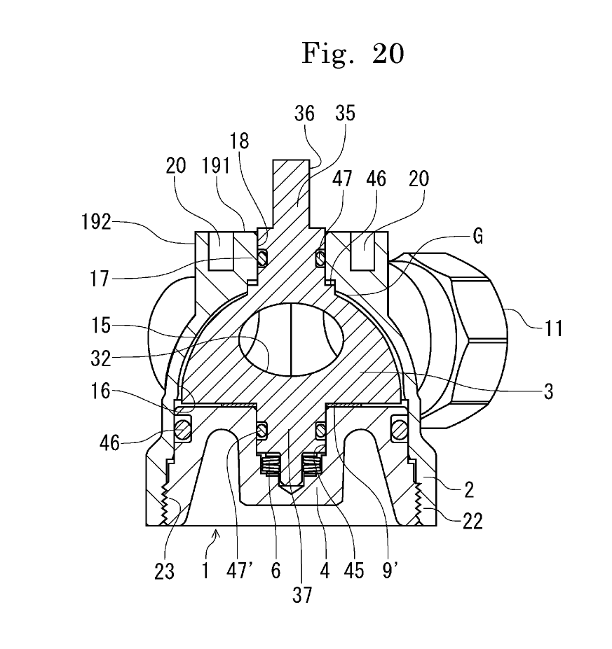

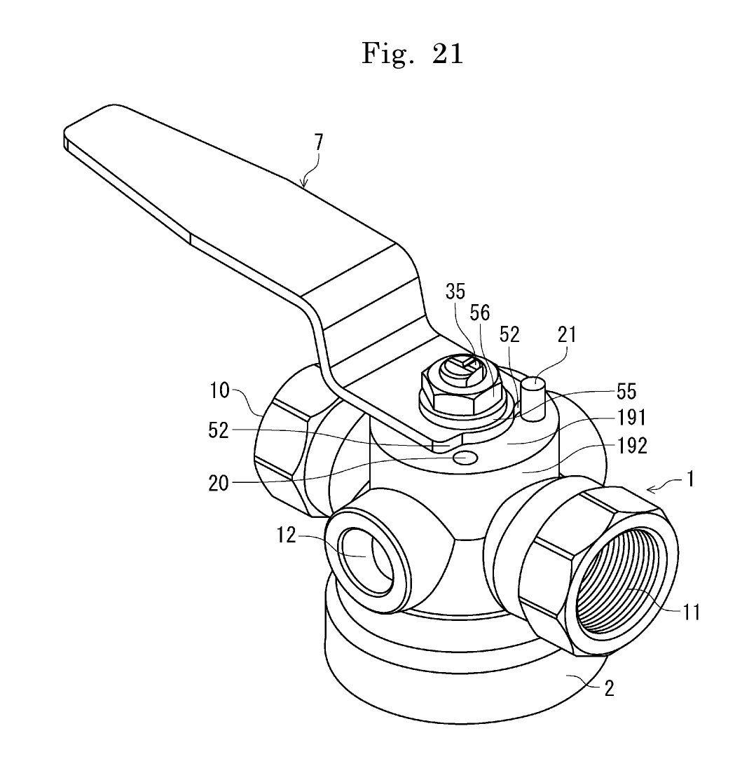

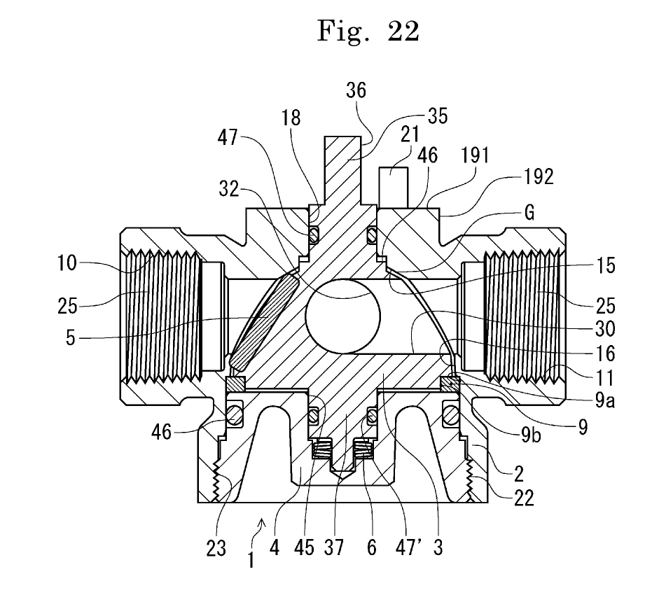

A third embodiment of the rapid exhaust valve for railway vehicles according to the present invention will then be described. FIG. 18 is a perspective view of an example of a rapid exhaust valve for railway vehicles according to a third embodiment of the present invention, and FIG. 19 is a vertical sectional view taken along a A-A sectional line of FIG. 18. FIG. 20 is a vertical sectional view taken along a 45-degree diagonal B-B sectional line of FIG. 18, and FIG. 21 is a perspective view showing the handle for manual operation attached to the rapid exhaust valve for railway vehicles according to the third embodiment of the present invention. FIG. 22 depicts another example of the rapid exhaust valve of the third embodiment shown in FIG. 18, presenting a vertical sectional view along the A-A sectional line that indicates a state of venting by the exhaust valve of another example of the rapid exhaust valve. The same constituent elements as described in the first embodiment or second embodiment will be denoted by the same reference numerals and will be omitted in further description.

According to the third embodiment, as shown in FIGS. 18, 19, and 20, a plane portion 191 making up an almost disc-shaped outer edge is formed on the top of the body 2 such that the plane portion 191 is formed integrally with the body 2 via an almost cylindrical side face 192. The plane portion 191 has the fitting hole 18 formed at its center, in which fitting hole 18 the upper stem 35 of the valve element 3 is fitted pivotally, and four mounting holes 20 formed at 90 degrees intervals. The locking pin 21 is inserted in any one of these mounting holes 20 by, for example, press fitting or screwing the locking pin 21. In this embodiment, the outflow/inflow port 10 is on the secondary side and the outflow/inflow port 11 is on the primary side.

In another example of the rapid exhaust valve as shown in FIG. 22, a fitting inner peripheral surface 9a is formed on the lower inner peripheral surface of the valve element housing portion 16 of the body 2, and a fitting step 9b is formed on the lower inner peripheral surface of the valve element 3. A holding ring 9 made of phosphor bronze or POM (Polyoxymethylene) resin is fitted on the fitting step 9b. As shown in FIG. 22, when the holding ring 9 is interposed between the lower inner peripheral surface of the valve element housing portion 16 and the lower outer peripheral surface of the valve element 3, the seal 5 can be compressed with its margin of compression kept constant as the spherical center of the spherical surface portion 15 of the body 2, the axis of the fitting hole 18, and the rotating axis of the valve element 3 are aligned by the inner/outer diameter cylindrical parts of the holding ring 9, the inner peripheral surface 9a of the body, and the step 9b of the valve element. This absorbs an eccentric action of the seal 5 caused by its compression reaction to eliminate the unevenness of the seal surface pressure of the seal 5, thereby improves the opening/closing operation performance of the exhaust valve.

### INDUSTRIAL APPLICABILITY

The rapid exhaust valve for railway vehicles according to the present invention is not limited to applications in the technical fields as described above, but may also be used as two-way, three-way, four-way, or multi-way rotary valve in the following technical fields. The rapid exhaust valve of the present invention may be used as a flow-adjusting rotary valve for channel switching incorporated in a heating medium (cool/hot water) control piping system, etc., of a heat exchanger, a rotary valve for flow adjustment or channel opening/closing incorporated in steam bypassing piping, etc., various multi-way valves for pipeline branching incorporated in a piping system for circulating high-pressure water, oil, gas, air, etc., various sanitary multi-way valves which can easily be assembled/disassembled and disinfected or flushed to make maintenance work easy, and various manual or automatic multi-way valves incorporate in a disaster preventing valve unit of a fire-extinguishing sprinkler facility for channel opening/closing, draining, testing, channel switching, etc.

1. A rapid exhaust valve for railway vehicles, wherein
outflow/inflow ports and an exhaust outlet are formed on a valve element housing portion having a spherical surface portion, the valve element housing portion being formed on a part of an inner periphery of a body, wherein
a valve element having a spherical surface portion is inserted rotatably in the valve element housing portion through an opening formed on the valve element housing portion, the valve element having a plurality of through-holes communicating with the outflow/inflow ports or the exhaust outlet and a fitting slot counter to the outflow/inflow ports that is formed in a direction crossing the through-holes, and wherein
when a seal that closes the outflow/inflow ports or the exhaust outlet is fitted in the fitting slot and the opening is closed with a lid, the seal seals up any one of the outflow/inflow ports or the exhaust outlet to allow the outflow/inflow port and the exhaust outlet or one outflow/inflow port and another outflow/inflow port to communicate with each other through the through-holes, and the area of the exhaust outlet is adjusted properly to be able to determine a venting time required for venting from a piping for an automatic door opening/closing gear in an emergency situation or during maintenance work to be a given time.

2. The rapid exhaust valve for railway vehicles according to claim 1, wherein
a holding ring is interposed between a lower inner peripheral surface of the valve element housing portion and a lower outer peripheral surface of the valve element.

3. The rapid exhaust valve for railway vehicles according to claim 1, wherein
a mechanism that adjusts the area of the exhaust outlet is an exhaust orifice formed in the exhaust outlet.

4. The rapid exhaust valve for railway vehicles according to claim 1, wherein
the exhaust outlet is almost identical in bore diameter with the outflow/inflow port.

5. The rapid exhaust valve for railway vehicles according to claim 1, wherein
a spring is disposed between the lid and the valve element, and the seal can be fastened further with the lid closing the opening, via the spring.

6. The rapid exhaust valve for railway vehicles according to claim 1, wherein
a nozzle capable of changing a venting direction is fitted in the exhaust outlet.

7. The rapid exhaust valve for railway vehicles according to claim 1, wherein
a dustproofing cap that prevents entry of a foreign object into the valve is connected to the body, the cap in its connected state opening the exhaust outlet when subjected to a pressure of discharged air in exhaust mode and returning to a closing position to close the exhaust outlet in non-exhaust mode.

8. The rapid exhaust valve for railway vehicles according to claim 1, wherein
the exhaust outlet is fitted with a muffler that reduces an exhaust sound.

9. The rapid exhaust valve for railway vehicles according to claim 1, wherein
the exhaust outlet is fitted with a check valve capable of opening in a venting direction, which check valve prevents entry of an extraneous foreign object or water into the exhaust outlet.

10. A rapid exhaust valve for railway vehicles, wherein
a valve element housing portion having a spherical surface portion is formed on a part of an inner periphery of a body having at least three or more outflow/inflow ports, wherein
a valve element having a spherical surface portion is inserted rotatably in the valve element housing portion through an opening formed on the valve element housing portion, the valve element having three or more through-holes communicating with the outflow/inflow ports and a fitting slot counter to the outflow/inflow ports that is formed in a direction crossing the through-holes, and wherein
a seal that closes the outflow/inflow ports is fitted in the fitting slot, the opening is closed with a lid that can be tightened further, and a resilient force of a spring disposed between the lid and the valve element causes the seal to seal up any one of the through-holes.

11. The rapid exhaust valve for railway vehicles according to claim 10, wherein
an upper stem formed on the valve element is fitted pivotally in a fitting hole formed on the body, via a seal, while a lower stem set opposite to the upper stem of the valve element is fitted pivotally in a fitting hole formed on the lid, via a seal to pivotally support the valve element between the body and the lid, thereby improve torque performance.

12. The rapid exhaust valve for railway vehicles according to claim 11, wherein
the upper stem and the lower stem are formed such that their shaft diameters are almost the same to apply an equal pressure.

13. The rapid exhaust valve for railway vehicles according to claim 11, wherein
the outflow/inflow ports are formed at 90 degrees intervals on the body such that an outflow/inflow port between two inline outflow/inflow ports serves an exhaust outlet and that directions of the two outflow/inflow ports are switched to reverse a direction of the exhaust outlet at 180 degrees, wherein
an operating handle having a stopper for regulating rotation is attached to the upper stem such that the operating handle can be set in arbitrary directions at 90 degrees intervals via an almost cross-shaped fitting hole, and wherein
mounting holes are formed at 90 degrees intervals at positions on the body at which the stopper is locked, and a locking pin allowing the stopper to be locked thereon is inserted in any one of the mounting holes to allow the handle to be shifted in an arbitrary opening/closing operation direction.

14. The rapid exhaust valve for railway vehicles according to claim 10, wherein
the lid is screwed into the opening via an O-ring such that a pressing force of the spring to the seal of the valve element can be adjusted by adjusting screwing of the lid.

15. A piping system of a railway vehicle, wherein
a plurality of the rapid exhaust valves for railway vehicles according to claim 1 are arranged in the middle of lines of a main pipe and a branch pipe or a pipeline branch section making up air piping that drives an automatic door opening/closing gear of the railway vehicle, and a variation in a venting time of each rapid exhaust valve is prevented to keep the venting time constant.

16. The piping system of the railway vehicle according to claim 15, wherein
the rapid exhaust valve for railway vehicles is disposed in the middle of pressure piping for door opening that is provided inside or outside the railway vehicle.

17. A piping system of a railway vehicle, wherein
a plurality of the rapid exhaust valves for railway vehicles according to claim 10 are arranged in the middle of lines of a main pipe and a branch pipe or a pipeline branch section making up air piping that drives an automatic door opening/closing gear of the railway vehicle, and a variation in a venting time of each rapid exhaust valve is prevented to keep the venting time constant.
